(19) United States
(12) Patent Application Publication
(10) Pub. No.: US 2019/0285951 A1
(43) Pub. Date: Sep. 19, 2019

(54) LIQUID CRYSTAL DISPLAY DEVICE AND METHOD FOR PRODUCING SAME

(71) Applicant: JSR CORPORATION, TOKYO (JP)

(72) Inventors: Koichi MIYACHI, Tokyo (JP); Yoshiaki MARUYAMA, Tokyo (JP); Shiro HIROTA, Tokyo (JP)

(73) Assignee: JSR CORPORATION, TOKYO (JP)

(21) Appl. No.: 16/465,568

(22) PCT Filed: Nov. 30, 2017
(86) PCT No.: PCT/JP2017/043179

§ 371 Date: May 30, 2019

(30) Foreign Application Priority Data
Dec. 2, 2016 (JP) 2016-235409

(51) Int. Cl. G02F 1/1337; G02F 1/137; G02F 1/1339; G02F 1/1343; C09K 19/54

(52) U.S. Cl. CPC G02F 1/133753; G02F 1/137; G02F 1/133711; G02F 1/13394; G02F 1/1368; C09K 19/54; G02F 2001/13706; G02F 2001/133757; G02F 2001/133749; G02F 1/134309

(57) ABSTRACT

This liquid crystal display device is provided with: a first substrate; a second substrate that faces the first substrate; a liquid crystal layer that is arranged between the first substrate and the second substrate; and liquid crystal alignment films (a first alignment film and a second alignment film) that are formed on the first substrate and the second substrate, respectively. The first substrate and the second substrate respectively have an electrode on the liquid crystal layer side surfaces. At least one of the first alignment film and the second alignment film is a photo-alignment film. Each pixel has a plurality of alignment regions, in which the alignment directions of liquid crystal molecules are different from each other, within the pixel. The liquid crystal layer has negative dielectric anisotropy, while having a thickness of 2.9 μm or less.

### CROSS-REFERENCE TO RELATED APPLICATION

Priority is claimed on Japanese Patent Application No. 2016-235409, filed Dec. 2, 2016, the content of which is incorporated herein by reference.

### TECHNICAL FIELD

The present disclosure relates to a liquid crystal display and a method for producing the same.

### BACKGROUND ART

Liquid crystal televisions have become widely used because they are thin and can be applied to digital broadcasting. In particular, in digital broadcasting, since display is accurate with the number of pixels in full high-definition televisions (for example, 1920 pixels×1080 pixels), significant improvement in image quality has been achieved and the place of current mainstream CRT televisions has been taken. In recent years, in order to obtain a sense of realism according to further improvement in the display quality, a display device standard such as 4K (for example, 3840 pixels×2160 pixels) and 8K (for example, 7680 pixels×4320 pixels) with an increased number of pixels has been realized, and broadcasting and internet delivery have been started therewith.

Regarding a liquid crystal display, a vertically aligned type liquid crystal display mode according to photo-alignment has been proposed and actually produced and applied to a liquid crystal television (for example, refer to Patent Literature 1 to 3). In this liquid crystal display mode, alignment division in one pixel is performed according to photo-alignment processing. Accordingly, a higher response speed and higher transmittance than those of a liquid crystal display in a multi-domain vertical alignment (MVA) mode or a patterned vertical alignment (PVA) mode in which alignment division in a pixel is realized by an electrode slit or a projection structure (rib) are realized.

### CITATION LIST

### Patent Literature

[Patent Literature 1]

Japanese Patent No. 4666398
[Patent Literature 2]

Japanese Patent No. 4666417
[Patent Literature 3]

Japanese Patent No. 4744518

### SUMMARY OF INVENTION

### Technical Problem

A display principle of a liquid crystal television is that liquid crystal elements serve as light shutters and a backlight disposed on the back surface controls light in units of pixels. Therefore, the light utilization efficiency of the backlight depends on a pixel transmittance, and when the pixel transmittance is low, power consumption increases, and additionally, the number of components (an LED chip and the like) of the backlight increases, and thus this is undesirable in consideration of resource saving and costs. Therefore, a liquid crystal display with high pixel transmittance is necessary.

On the other hand, it can be understood that, in a vertically aligned type liquid crystal display on which alignment division is performed by photo-alignment processing, dark lines (boundary) generated by alignment division for securing a viewing angle performance are provided in light transmission areas of pixels during white display, and the pixel transmittance is lowered. In particular, in a small screen size assuming personal use and in standards such as 4K or 8K with an increased number of pixels, since the pixel size is smaller, a proportion of the light transmission area in each pixel occupied by dark lines relatively increases. Therefore, there is a problem of decrease in the transmittance due to more dark lines appearing.

The present disclosure has been made in view of the above problem, and an object of the present disclosure is to provide a liquid crystal display which has a plurality of areas in which alignment directions are different from each other in a pixel and through which high transmittance can be realized.

### Solution to Problem

The present disclosure provides the following aspects in order to address the above problems.

[1] A liquid crystal display including a first substrate, a second substrate that faces the first substrate, a liquid crystal layer disposed between the first substrate and the second substrate, and a liquid crystal alignment film formed on each of the first substrate and the second substrate, wherein each of the first substrate and the second substrate has an electrode located on its surface on the liquid crystal layer side, wherein the liquid crystal alignment film includes a first alignment film formed on a surface of the first substrate on which the electrode is disposed, and a second alignment film formed on a surface of the second substrate on which the electrode is disposed, and at least one of the first alignment film and the second alignment film is a photo-alignment film, wherein a plurality of alignment areas in which alignment directions of liquid crystal molecules in the liquid crystal layer are different from each other are formed in one pixel, and wherein the liquid crystal layer contains liquid crystal molecules having negative dielectric anisotropy and a thickness of the liquid crystal layer is 2.9 μm or less.

[2] The liquid crystal display according to [1], wherein the thickness of the liquid crystal layer is 2.7 μm or less.

[3] The liquid crystal display according to [1], wherein the thickness of the liquid crystal layer is 2.5 μm or less.

[4] The liquid crystal display according to any one of [1] to [3], wherein the pretilt angle of the photo-alignment film is less than 88.5 degrees.

[5] A liquid crystal display including a first substrate, a second substrate that faces the first substrate, a liquid crystal layer disposed between the first substrate and the second substrate, and a liquid crystal alignment film formed on each of the first substrate and the second substrate, wherein each of the first substrate and the second substrate has an electrode located on its surface on the liquid crystal layer side, wherein the liquid crystal alignment film includes a first alignment film formed on a surface of the first substrate on which the electrode is disposed, and a second alignment film formed on a surface of the second substrate on which the electrode is disposed, and at least one of the first alignment film and the second alignment film is a photo-alignment film, wherein a plurality of alignment areas in which alignment directions of liquid crystal molecules in the liquid crystal layer are different from each other are formed in one pixel, and wherein the liquid crystal layer contains liquid crystal molecules having negative dielectric anisotropy, and wherein the pretilt angle of the photo-alignment film is less than 88.5 degrees.

[6] The liquid crystal display according to [4] or [5], wherein the pretilt angle of the photo-alignment film is less than 88.3 degrees.

[7] The liquid crystal display according to any one of [4] to [6], wherein the first alignment film and the second alignment film are a photo-alignment film, and wherein the liquid crystal layer has a retardation value that is equal to or greater than a value satisfying the following Formula (1):

R=−10.806×P+1264.4 (1)

(in Formula (1), P is a pretilt angle (deg.) of the photo-alignment film, and R is a retardation value (nm)).

[8] The liquid crystal display according to any one of [1] to [7], wherein the liquid crystal molecules are aligned so that a projection direction of which a long axis direction of the liquid crystal molecules in the vicinity of the first alignment film extends and a projection direction of which a long axis direction of the liquid crystal molecules in the vicinity of the second alignment film extends are orthogonal to each other.

[9] The liquid crystal display according to any one of [1] to [6], wherein the liquid crystal molecules are aligned so that a projection direction of which a long axis direction of the liquid crystal molecules in the vicinity of the first alignment film extends and a projection direction of which a long axis direction of the liquid crystal molecules in the vicinity of the second alignment film extends are antiparallel to each other.

[10] The liquid crystal display according to any one of [1] to [6], wherein a pretilt angle of one of the first alignment film and the second alignment film is less than 90 degrees, and a pretilt angle of the other one is 90 degrees.

[11] The liquid crystal display according to any one of [1] to [10], wherein the pixel width is 250 μm or less.

[12] The liquid crystal display according to any one of [1] to [11], wherein the liquid crystal layer contains at least one compound selected from the group consisting of a compound having a biphenyl framework, a compound having a terphenyl framework and a compound having a quaternary phenyl framework in an amount of 30 mass % or more with respect to the total amount of the liquid crystal layer.

[13] The liquid crystal display according to any one of [1] to [12], wherein the pixel includes, as the plurality of alignment areas, at least a first domain in which an alignment direction of the liquid crystal molecules is in a first direction and a second domain in which an alignment direction of the liquid crystal molecules is in a second direction different from the first direction and which is adjacent to the first domain, and wherein at the boundary between the first domain and the second domain, a ratio (W/d) of a width W of an area in which the brightness is 0.5 or less when the maximum brightness in an area formed of the first domain and the second domain during white display is set as 1 to a thickness d of the liquid crystal layer is 2.0 or less.

[14] The liquid crystal display according to any one of [1] to [13], wherein the pixel includes a thin film transistor as a switching element, and wherein a semiconductor constituting the thin film transistor is any of materials obtained by performing laser annealing on an oxide semiconductor, a low temperature polysilicon, and amorphous silicon.

[15] A method for producing a liquid crystal display, including: a process A in which a liquid crystal alignment film is formed on an electrode disposition surface of each of a first substrate and a second substrate which have an electrode on their surfaces; and a process B in which the first substrate and second substrate obtained in the process A are disposed so that the liquid crystal alignment films face each other with a liquid crystal layer containing liquid crystal molecules having negative dielectric anisotropy located therebetween to form a liquid crystal cell, wherein the process A includes a process in which at least one of the first substrate and the second substrate is subjected to alignment processing by performing light emission on a coating film formed using a liquid crystal alignment agent, and thus a plurality of alignment areas in which alignment directions of the liquid crystal molecules are different from each other are formed in one pixel, and wherein the thickness of the liquid crystal layer is 2.9 μm or less.

[16] A method for producing a liquid crystal display, including: a process A in which a liquid crystal alignment film is formed on an electrode disposition surface of each of a first substrate and a second substrate which have an electrode on their surfaces; and a process B in which the first substrate and second substrate obtained in the process A are disposed so that the liquid crystal alignment films face each other with a liquid crystal layer containing liquid crystal molecules having negative dielectric anisotropy located therebetween to form a liquid crystal cell, wherein the process A includes a process in which at least one of the first substrate and the second substrate is subjected to alignment processing by performing light emission on a coating film formed using a liquid crystal alignment agent, and thus a plurality of alignment areas in which alignment directions of the liquid crystal molecules are different from each other are formed in one pixel, and wherein the pretilt angle of the liquid crystal alignment film subjected to alignment processing by the light emission is less than 88.5 degrees.

[17] The method for producing a liquid crystal display according to [15] or [16], wherein a spacer formed between the first substrate and the second substrate is formed using a radiation-sensitive resin composition containing an oxime ester type radical polymerization initiator.

### Advantageous Effects of Invention

According to the present disclosure, in a vertically aligned type liquid crystal display on which alignment division is performed in a pixel, it is possible to narrow the width of the dark line generated in the pixel during white display due to alignment division, and as a result, the transmittance can be improved.

### BRIEF DESCRIPTION OF DRAWINGS

The above object and other objects, features and advantages of the present disclosure will be more clearly understood according to the following detailed description with reference to the appended drawings.

FIG. 1 is a schematic diagram showing a schematic configuration of a liquid crystal display.

FIG. 2 is a diagram showing one example of a pixel area divided by alignments according to photo-alignment processing.

FIG. 3 shows diagrams explaining a procedure of dividing the inside of a pixel by alignments according to photo-alignment processing, FIG. 3(a) shows a first substrate, and FIG. 3(b) shows a second substrate.

FIG. 4 is a diagram showing dark lines generated in a pixel area.

FIG. 5 is a diagram schematically showing a cross section taken along the line A-A in FIG. 4.

FIG. 6 shows diagrams of a procedure of dividing a pixel area by alignments performed in Example 1, FIG. 6(a) shows a first substrate, and FIG. 6(b) shows a second substrate.

FIG. 7 is a schematic diagram showing a state when a liquid crystal cell is observed from the front during white display.

FIG. 8 is a diagram showing the relationship between a thickness and a dark line width of a liquid crystal layer when the pixel width is 248 nm.

FIG. 9 is a diagram showing the relationship between a thickness and a dark line width of a liquid crystal layer when the pixel width is 124 nm.

FIG. 10 is a diagram showing the relationship between a thickness and a dark line width of a liquid crystal layer when the pixel width is 62 nm.

FIG. 11 is a diagram showing the relationship between a thickness and a relative transmittance of a liquid crystal layer for each thickness of the liquid crystal layer.

FIG. 12 is a diagram showing simulation results of the relationship between the position in the electrode width direction and the brightness when a pretilt angle is 89 degrees.

FIG. 13 is a diagram showing simulation results of the relationship between the position in the electrode width direction and the brightness when the pretilt angle is 88 degrees.

FIG. 14 is a diagram showing the relationship between the dark line width and the pretilt angle in the observation area.

FIG. 15 is a diagram showing the results of the relative transmittance when the pretilt angle and the thickness of the liquid crystal layer are changed obtained by a liquid crystal simulator.

FIG. 16 is a diagram showing the change in the highest point of the transmittance when the pretilt angle and the retardation value are changed.

FIG. 17 is a diagram showing the relationship between a transmittance, a pretilt angle, and a retardation value.

### DESCRIPTION OF EMBODIMENTS

### First Embodiment

A first embodiment will be described below with reference to the drawings. Hereinafter, in the following respective embodiments, the same or equivalent components will be denoted with the same reference numerals in the drawings and the same descriptions will be applied for components with the same reference numerals.

In this specification, a “pixel” is the minimum unit for expressing a shade (gradation) of each color in a display, and corresponds to, for example, a unit for expressing respective gradations of R, G, and B, in a color display device. Therefore, the expression “pixel” refers to R pixels, G pixels, and B pixels, individually rather than color display pixels (pixel elements) in which an R pixel, a G pixel, and a B pixel are combined. That is, in the case of a color display device, one pixel corresponds to any color of a color filter. The “pixel area” refers to a display area corresponding to one pixel, that is, a light transmission area of each pixel. The “pretilt angle” is an angle formed by a surface of an alignment film and a liquid crystal molecule in the vicinity of the alignment film in a long axis direction when the voltage is turned off.

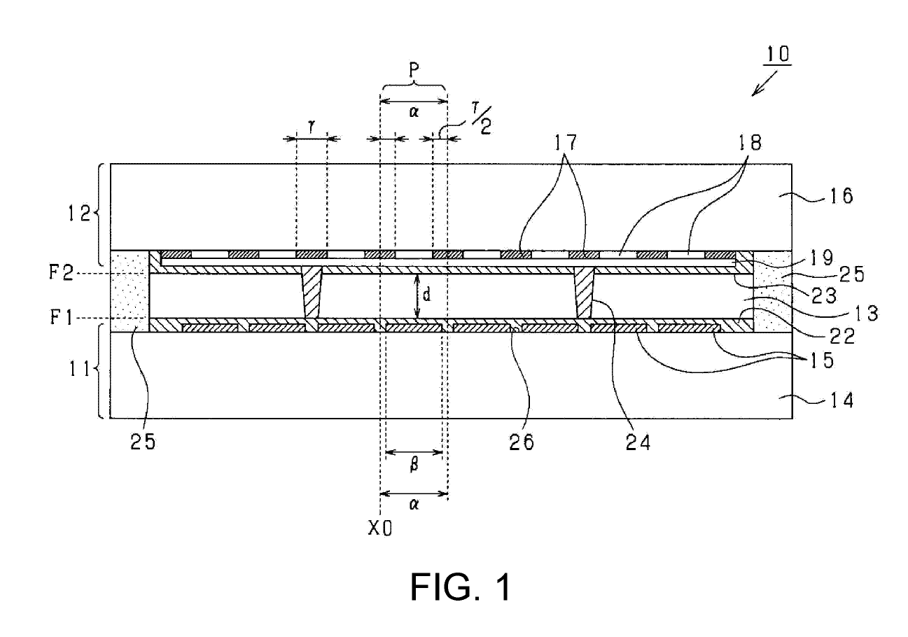

As shown in FIG. 1, a liquid crystal display 10 of the present embodiment includes a pair of substrates including a first substrate 11 and a second substrate 12, and a liquid crystal layer 13 disposed between the pair of substrates. While a thin film transistor (TFT) type liquid crystal display is described as a typical example in the present embodiment, obviously, it can be applied to other driving methods (for example, a passive matrix method, and a plasma addressing method).

The first substrate 11 has a transparent substrate 14 made of glass or the like, and a pixel electrode 15 made of a transparent conductor such as indium tin oxide (ITO), a TFT as a switching element, various wirings such as a scan line and a signal line, and the like are disposed on the surface of the transparent substrate 14 on the liquid crystal layer 13 side. The second substrate 12 has a transparent substrate 16 made of glass or the like, and on the surface of the transparent substrate 16 on the liquid crystal layer 13 side, a black matrix 17, a color filter 18, a counter electrode 19 (referred to as a common electrode) made of a transparent conductor, and the like are provided.

On respective electrode disposition surfaces of the first substrate 11 and the second substrate 12, a liquid crystal alignment film for aligning liquid crystal molecules in a predetermined direction with respect to the film surface is formed. The liquid crystal alignment film includes a first alignment film 22 formed on the electrode formation surface of the first substrate 11 and a second alignment film 23 formed on the electrode formation surface of the second substrate 12. The first alignment film 22 and the second alignment film 23 are a photo-alignment film formed using a material containing a polymer of which a liquid crystal alignment regulating force varies due to light emission. Here, the liquid crystal alignment film may be provided on at least one of the pair of substrates, and is preferably provided on both substrates in consideration of alignment stability.

The first substrate 11 and the second substrate 12 are disposed with a spacer 24 therebetween and with a predetermined gap (cell gap) therebetween so that the electrode disposition surface of the first substrate 11 and the electrode disposition surface of the second substrate 12 face each other. Here, in FIG. 1, while a columnar spacer is shown as the spacer 24, a bead spacer or the like may be used. Peripheral parts of the pair of substrates 11 and 12 disposed to face other are bonded to each other via a sealing material 25. A liquid crystal composition is filled into a space surrounded by the first substrate 11, the second substrate 12, and the sealing material 25 and thereby the liquid crystal layer 13 is formed.

Polarizing plates (not shown) are disposed outside the first substrate 11 and the second substrate 12. A terminal area is provided at the outer edge of the first substrate 11, a driver IC for driving a liquid crystal or the like is connected to the terminal area, and thereby the liquid crystal display 10 is driven.

The liquid crystal display 10 is of a vertically aligned type, and liquid crystal molecules having negative dielectric anisotropy are contained in the liquid crystal layer 13. In pixels disposed in the display area of the liquid crystal display 10, a plurality of alignment areas having different alignment directions are formed by photo-alignment processing. Therefore, viewing angle characteristics of the liquid crystal display 10 are compensated for.

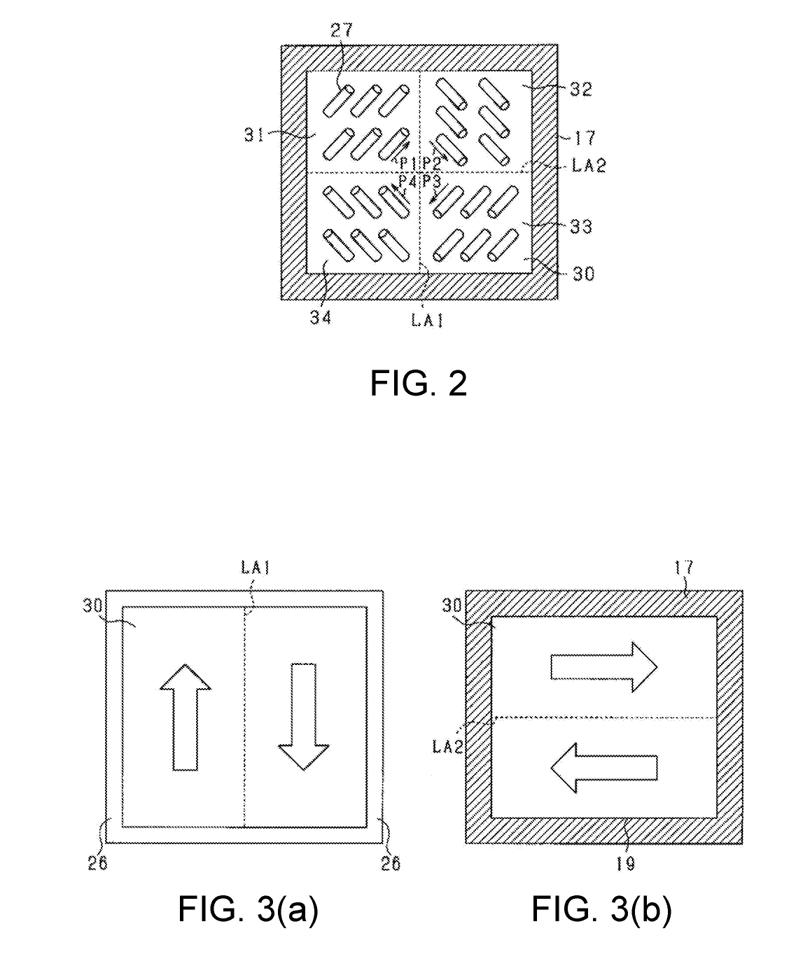

Specifically, in the pixel areas, at least a first domain in which an alignment direction of liquid crystal molecules is in a first direction and a second domain in which an alignment direction of liquid crystal molecules is in a second direction different from the first direction and which is adjacent to the first domain are formed. As a specific example, a pixel area 30 having a 4-division domain structure is shown in FIG. 2. While the shape of the pixel area 30 is shown as substantially square in FIG. 2 for convenience, the shape of the pixel area 30 is not limited thereto, and it may be, for example, a rectangular shape.

In the pixel area 30 shown in FIG. 2, four liquid crystal domains including a first domain 31, a second domain 32, a third domain 33 and a fourth domain 34 are formed, and the plurality of liquid crystal domains 31 to 34 are disposed adjacent to each other in a 2-row and 2-column matrix form. In FIG. 2, the symbols LA1 and LA2 indicate boundaries of domain division.

In the four liquid crystal domains 31 to 34, alignment directions (tilt directions) of liquid crystal molecules when the voltage is turned on are different from each other. Specifically, regarding a tilt direction (hereinafter referred to as a “reference alignment direction”) of liquid crystal molecules in the layer plane of the liquid crystal layer 13 and near the center in the thickness direction when a voltage is applied, when the first domain 31 is in a first direction p1, the second domain 32 is in a second direction p2, the third domain 33 is in a third direction p3, and the fourth domain 34 is in a fourth direction p4, a difference between any two alignment directions among the first direction p1, the second direction p2, the third direction p3, and the fourth direction p4 is approximately equal to an integral multiple of 90 degrees. Here, in FIG. 2, directions indicated by arrows (p1 to p4) show that liquid crystal molecules 27 are aligned toward the surface side on which the liquid crystal display 10 is observed.

The liquid crystal alignment film formed on each substrate is subjected to photo-alignment processing so that a projection direction of which a long axis direction of the liquid crystal molecules in the vicinity of the first alignment film 22 extends and a projection direction of which a long axis direction of the liquid crystal molecules in the vicinity of the second alignment film 23 extends are orthogonal to each other. This mode is also referred to as a vertical alignment twisted nematic (VATN) mode.

A procedure of alignment-dividing the inside of one pixel by photo-alignment processing will be described with reference to FIG. 3. Here, a case in which the inside is divided into four alignments will be described as one example. Here, white arrows in FIG. 3 indicate an exposure direction of polarized ultraviolet light, and FIG. 3(a) shows an alignment division applied to the first substrate 11, and FIG. 3(b) shows an alignment division applied to the second substrate 12.

First, in the first substrate 11, regarding a coating film formed using a polymer composition for forming an alignment film (hereinafter referred to as a “liquid crystal alignment agent”), as shown in FIG. 3(a), the pixel area 30 is divided into two parts, and photo-alignment processing is performed on respective areas so that exposure directions are antiparallel to each other. In addition, in the second substrate 12, regarding a coating film formed using a liquid crystal alignment agent, as shown in FIG. 3(b), the pixel area 30 is divided into two parts in a direction orthogonal to the exposure direction of the first substrate 11, and photo-alignment processing is performed so that exposure directions of two divided areas are antiparallel to each other.

In the present embodiment, regarding photo-alignment processing, polarized ultraviolet light is obliquely emitted a plurality of times using a photomask. Then, when the first substrate 11 and the second substrate 12 are bonded so that exposure directions are orthogonal to each other, a 4-division alignment pixel shown in FIG. 2 is obtained. A reference alignment direction after a liquid crystal is injected is defined in the intermediate direction between the first alignment film 22 in the exposure direction and the second alignment film 23 in the exposure direction. Here, tilt directions of the four liquid crystal domains 31 to 34 are not limited to the directions shown in FIG. 2 as long as tilt directions of domains are different from each other.

The liquid crystal alignment film is formed using a polymer composition (liquid crystal alignment agent) in which a polymer component is dissolved or dispersed in an organic solvent. The main chain of the polymer component in the liquid crystal alignment agent is not particularly limited, but at least one selected from the group consisting of a polyamic acid, a polyamic acid ester, a polyimide, a polyamide and a polyorganosiloxane can be particularly preferably used.

The liquid crystal alignment agent for forming the first alignment film 22 and the second alignment film 23 preferably contains a polymer having a photoalignable group as a polymer component. Here, the photoalignable group refers to a group that exhibits liquid crystal alignment properties due to photoisomerization, photodimerization, photolysis, photo-Fries rearrangement, light re-alignment or the like. Specific examples of a preferable photoalignable group include, for example, an azo-containing group containing an azo compound or derivatives thereof as a basic framework, a cinnamic acid-containing group having a cinnamic acid structure containing cinnamic acid or derivatives thereof as a basic framework, a phenyl benzoate-containing group containing phenyl benzoate or derivatives thereof as a basic framework, and a cyclobutane-containing structure containing cyclobutane or derivatives thereof as a basic framework. Among these, a cinnamic acid-containing group is particularly preferable because it exhibits excellent liquid crystal alignment properties with a small light emission amount.

Specific examples of a preferable cinnamic acid-containing group include, for example, a group represented by the following Formula (cn-1) and a group represented by the following Formula (cn-2).

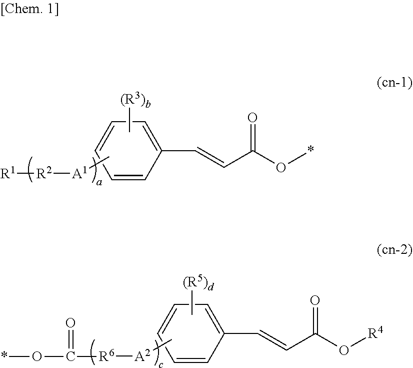

(In Formula (cn-1), R¹ is a hydrogen atom, a halogen atom, an alkyl group having 1 to 3 carbon atoms or an alkoxy group having 1 to 3 carbon atoms. R² is a phenylene group, a biphenylene group, a terphenylene group or a cyclohexylene group, or a group in which at least some of hydrogen atoms contained in such groups are substituted with a halogen atom, an alkyl group having 1 to 10 carbon atoms, a halogenated alkyl group having 1 to 10 carbon atoms, an alkoxy group having 1 to 10 carbon atoms, or a halogenated alkoxy group having 1 to 10 carbon atoms. A¹ is a single bond, an oxygen atom, sulfur atom, an alkanediyl group having 1 to 3 carbon atoms, —CH═CH—, —NH—, *¹-COO—, *¹-OCO—, *¹-NH—CO—, *¹-CO—NH—, *¹-CH₂—O— or *¹-O—CH₂— (“*¹” indicates a bond with R²). R³ is a halogen atom, an alkyl group having 1 to 3 carbon atoms, or an alkoxy group having 1 to 3 carbon atoms. a is 0 or 1, and b is an integer of 0 to 4. Here, when b is 2 or more, a plurality of R³ may be the same as or different from each other. “*” indicates a bond.

In Formula (cn-2), R⁴ is an alkyl group having 1 to 3 carbon atoms. R⁵ is a halogen atom, an alkyl group having 1 to 3 carbon atoms, or an alkoxy group having 1 to 3 carbon atoms. A² is an oxygen atom, *¹-COO—, *¹-OCO—, *¹-NH—CO— or *¹-CO-NH— (“*¹” indicates a bond with R⁶). R⁶ is an alkanediyl group having 1 to 6 carbon atoms. c is 0 or 1, and d is an integer of 0 to 4. Here, when d is 2 or more, a plurality of R⁵ may be the same as or different from each other. “*” indicates a bond.

The polymer component in the liquid crystal alignment agent preferably has a vertical alignment group in order to realize expression of a desired pretilt angle. The vertical alignment group is a group exhibiting a property of vertical aligning liquid crystal molecules without light emission, and specifically, for example, an alkyl group having 3 to 30 carbon atoms, a fluoroalkyl group having 3 to 30 carbon atoms, a group having a framework in which a total of two or more of at least one of a cyclohexylene ring and a benzene ring are connected, and a group having a steroid framework may be exemplified.

The vertical alignment group may be contained in a polymer having a photoalignable group, or may be contained in a polymer different from a polymer having a photoalignable group. Regarding the polymer component in the liquid crystal alignment agent, a polymer having a photoalignable group and a vertical alignment group can be preferably used. In the polymer, a content of a structural unit Q having a vertical alignment group is preferably 3 to 20 mole % and more preferably 4 to 10 mole % with respect to a total amount of a structural unit P having a photoalignable group and the structural unit Q.

The liquid crystal alignment agent may contain a polymer (hereinafter referred to as “the other polymer”) having neither a photoalignable group nor a vertical alignment group in order to control a pretilt angle of the liquid crystal alignment film. Examples of the other polymer include a polymer exhibiting a property (horizontal alignment property) of horizontal aligning liquid crystal molecules without light emission. Here, a pretilt angle can be reduced by increasing a content of the polymer exhibiting photoalignable properties with respect to the polymer having a vertical alignment group.

The content of the other polymer is preferably 30 mass % or less, more preferably 20 mass % or less, and most preferably 10 mass % or less with respect to the total amount of the polymer component contained in the liquid crystal alignment agent.

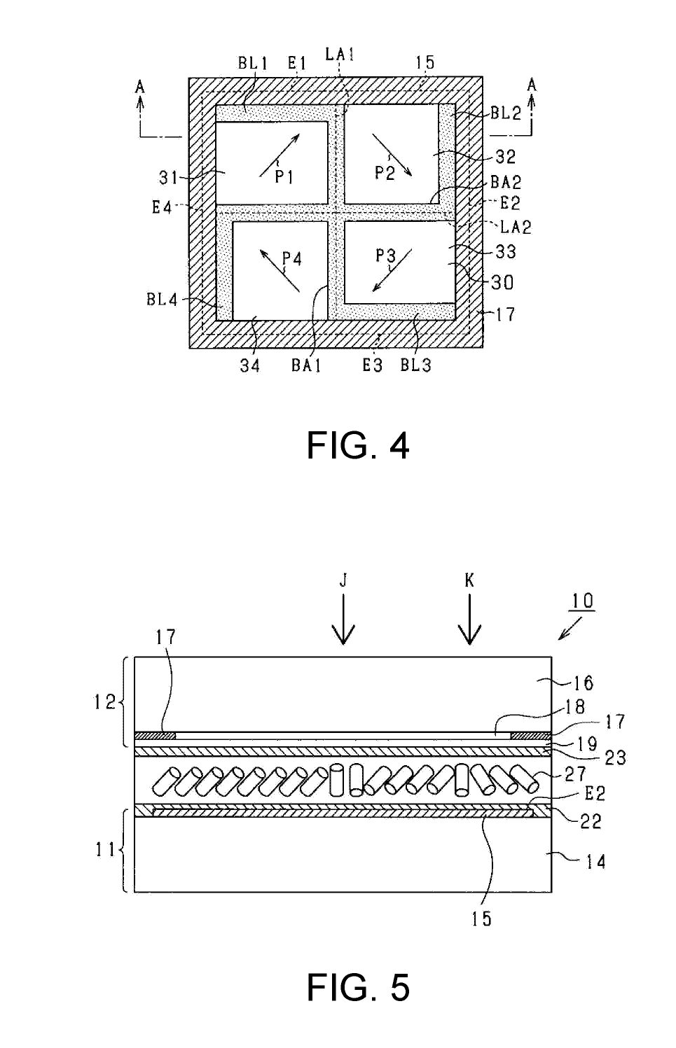

Here, in the liquid crystal display 10 subjected to pixel alignment division by photo-alignment processing, during white display of the liquid crystal display 10, in areas corresponding to the boundaries LA1 and LA2 of alignment divisions, dark lines extending in the length direction of the boundaries LA1 and LA2 are observed. For example, in the case of four separate domains as shown in FIG. 2 and FIG. 3, then as shown in FIG. 4, when the liquid crystal display 10 is viewed from the observation surface side, a dark line BA1 extending in the length direction of the boundary LA1 of the alignment division of the first substrate 11 and a dark line BA2 that extends in the length direction of the boundary LA2 of the alignment division of the second substrate 12 and crosses the dark line BA1 are observed in the central part of the pixel area 30.

In addition, in each pixel, at the outer end of the pixel area 30, dark lines are observed when the pixel area 30 is viewed from the observation surface side during white display of the liquid crystal display 10. Specifically, in the pixel electrode 15, four electrode ends are formed with 4 sides, and among such electrode ends, in an area near the electrode end in which a direction orthogonal to the electrode end which is a direction inward in the pixel electrode 15 forms an angle of greater than 90 degrees with the tilt direction of each liquid crystal domain, a dark line extending in the direction along the electrode end is observed.

For example, in the case of four separate domains as shown in FIG. 2, then as shown in FIG. 4, in the first domain 31, near an electrode end E1 in which a direction orthogonal to the electrode end which is a direction inward in the pixel electrode 15 forms an angle of greater than 90 degrees with the first tilt direction p1, a dark line BL1 extending in the direction along the electrode end E1 is observed. In addition, in the second domain 32, near an electrode end E2 in which a direction orthogonal to the electrode end which is a direction inward in the pixel electrode forms an angle of greater than 90 degrees with the second tilt direction p2, a dark line BL2 extending in the direction along the electrode end E2 is observed. Similarly, in the third domain 33 and the fourth domain 34, near the electrode end in which a direction orthogonal to the electrode end which is a direction inward in the pixel electrode 15 forms an angle of greater than 90 degrees with the tilt direction of each of the domains, dark lines BL3 and BL4 extending in the direction along the electrode end are observed.

Here, the dark lines BA1 and BA2 in the central part of the pixel area 30 and the dark lines BL1 to BL4 near the electrode end of the pixel electrode 15 are considered to be dark lines derived from liquid crystal continuous deformation. That is, the dark lines BA1 and BA2 in the central part of the pixel area 30 are assumed to be caused by misalignment at the alignment division boundary. In addition, regarding the dark lines BL1 to BL4 near the electrode end of the pixel electrode 15, an electric field direction between the electrode end of the pixel electrode 15 and the counter electrode 19 is inclined from the direction normal to the substrate, and a liquid crystal alignment direction according to its oblique electric field is different from a liquid crystal alignment direction according to photo-alignment processing. Therefore, the boundary caused by the antagonism is assumed to be observed as a dark line.

FIG. 5 schematically shows the relationship between a position of a dark line and a liquid crystal alignment direction. Here, FIG. 5 shows a cross section taken along the A-A in FIG. 4. In FIG. 5, the arrow J corresponds to the dark line BA1 in the central part of the pixel area 30, and the arrow K corresponds to the dark line BL2 near the electrode end E2 of the pixel electrode 15. It is thought that misalignment of the liquid crystal molecules 27 occurs in an area indicated by the arrow J and an area indicated by the arrow K, and thus the dark lines are generated.

It is preferable that the dark lines BA1, BA2, and BL1 to BL4 generated in the pixel area 30 be as thin as possible in order to reduce the pixel transmittance. Thus, the inventors conducted extensive studies in order to make the dark line thin, and found that, when the thickness d of the liquid crystal layer 13 is made thin, the width of the dark line generated by alignment division in the pixel can be narrowed.

That is, in the liquid crystal display 10, the thickness d of the liquid crystal layer 13 is 2.9 μm or less. In order to further narrow the width of the dark line generated in the pixel area 30, the thickness d is preferably 2.7 μm or less and more preferably 2.5 μm or less. The lower limit of the thickness d is not particularly limited, and it is preferably 1.8 μm or more, more preferably 1.9 μm or more, and most preferably 2.0 μm or more in order to both prevent a reduction in the product yield and improve the pixel transmittance. Here, in this specification, the “thickness of the liquid crystal layer” is a length of the liquid crystal layer 13 in the thickness direction in a light transmission area of a pixel, and specifically, refers to a distance from an interface F1 between the first alignment film 22 and a liquid crystal to an interface F2 between the second alignment film 23 and a liquid crystal F2 in the light transmission area of the pixel when the liquid crystal alignment film is formed on both substrates.

A retardation (Δn·d) which is a product of the refractive index anisotropy Δn of the liquid crystal and the thickness d of the liquid crystal layer 13 is preferably 300 nm or more and more preferably 320 nm or more in order to obtain the liquid crystal display 10 having a sufficiently high transmittance. Therefore, it is preferable to select the liquid crystal according to the thickness d of the liquid crystal layer 13 so that the value of retardation is within the above range. Specifically, the liquid crystal layer 13 preferably contains at least one selected from the group consisting of compounds represented by the following Formula (1-1) to Formula (1-6). Here, in this specification, the measurement wavelength of the refractive index anisotropy Δn is about 546 nm (for example, a wavelength within a range of 546 to 550 nm).

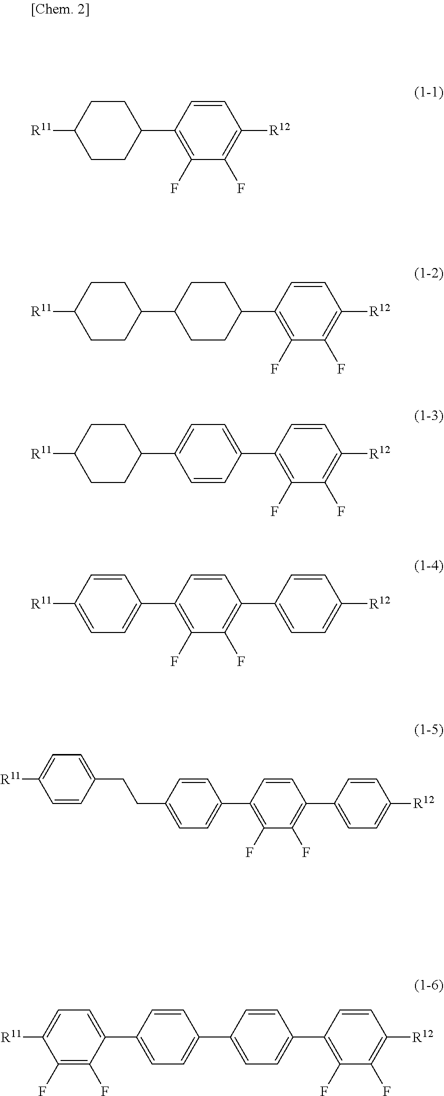

(In the formula, R¹¹ and R¹² each independently represent an alkyl group or alkoxyl group having 1 to 8 carbon atoms or an alkenyl group or alkenyloxy group having 2 to 8 carbon atoms.)

In addition, in order to secure retardation in a desired range, the liquid crystal layer 13 preferably contains at least one compound (hereinafter referred to as a “polycyclic liquid crystal compound M”) selected from the group consisting of a compound having a biphenyl framework, a compound having a terphenyl framework and a compound having a quaternary phenyl framework. Specific examples of the polycyclic liquid crystal compound M include, for example, compounds represented by Formula (1-3) to Formula (1-6). In the polycyclic liquid crystal compound M, at least some of hydrogen atoms in a benzene ring are preferably substituted with a fluorine atom or a chlorine atom, and particularly preferably substituted with a fluorine atom in consideration of reliability. The number of substituents is not particularly limited, and may be for example, 1 to 4. In order to obtain a large refractive index anisotropy Δn, a content of the polycyclic liquid crystal compound M is preferably 30 mass % or more and more preferably 40 mass % or more with respect to the total amount of the liquid crystal composition constituting the liquid crystal layer 13.

On the other hand, when the content of the polycyclic liquid crystal compound M is too large, the viscosity of the liquid crystal becomes too high, and a moving image display performance (response time) of the liquid crystal display 10 tends to degrade. In view of these, the upper limit value of the content of the polycyclic liquid crystal compound M in the liquid crystal layer 13 is preferably 90 mass % or less and more preferably 80 mass % or less. In addition, in consideration of a balance between the refractive index anisotropy Δn and the liquid crystal viscosity, a compound having a terphenyl framework can be preferably used as the polycyclic liquid crystal compound M. The content of the compound having a terphenyl framework is preferably 25 mass % or more and more preferably 30 mass % or more with respect to the total amount of the polycyclic liquid crystal compound M contained in the liquid crystal layer 13.

The pixel transmittance improvement effect obtained by reducing the thickness d of the liquid crystal layer 13 is particularly effective when the pixel size is small. For example, since the pixel size is large in a large full high-definition television such as a 52 type or 60 type TV, a proportion of the pixel area 30 occupied by dark lines is relatively small. Therefore, the influence of pixel transmittance due to the dark lines generated by domain division is weak. On the other hand, in a small screen size or a standard with a large number of pixels (for example, 4K or 8K), the pixel size is small and a proportion of the pixel area occupied by dark lines 30 relatively increases. Therefore, reduction in the pixel transmittance tends to be more significant.

Specifically, in order to obtain a sufficient transmittance improvement effect, application to the liquid crystal display 10 having a pixel width of 250 μm or less is preferable. The pixel width is more preferably 200 μm or less, most preferably 150 μm or less, and particularly preferably 130 μm or less. Here, in this specification, the “pixel width” refers to a distance (α in FIG. 1) between the centers of two adjacent electrode gaps 26. When the length in the row direction is different from the length in the column direction in one pixel, the pixel width refers to a width when viewed in a direction with a shorter length between the row direction and the column direction. That is, when the shape of the pixel is a rectangle, a distance between the centers of two adjacent electrode gaps 26 when viewed in the short side direction corresponds to the pixel width.

In the liquid crystal display 10, the pretilt angle θ of the photo-alignment film (the first alignment film 22 and the second alignment film 23) is an arbitrary value of 90 degrees or less, and is preferably less than 88.5 degrees. When the pretilt angle θ is less than 88.5 degrees, it is suitable because the liquid crystal display 10 with a higher pixel transmittance can be obtained. The pretilt angle θ is more preferably less than 88.3 degrees, and most preferably less than 88.0 degrees. The lower limit value of the pretilt angle θ is not particularly limited, and is preferably 86.4 degrees or more and more preferably 87.1 degrees or more in consideration of the transmittance. In the present embodiment, the pretilt angles θ of the first alignment film 22 and the second alignment film 23 are the same. However, “the pretilt angles θ are the same” means that a slight difference in the pretilt angle θ is allowable as long as the effects of the present disclosure are not impaired.

When the thickness d of the liquid crystal layer 13 is made thin, the electrical capacitance of the liquid crystal cell increases in inverse proportion to the thickness d. Therefore, when the thickness d is made thin, it is preferable to increase the size of a TFT for charging the pixel and maintain a charging rate. On the other hand, when the size of the TFT increases, the pixel transmittance (aperture rate) is reduced. Therefore, it is preferable to minimize the influence of thinning the thickness d by using a TFT using a semiconductor material having high mobility. Specifically, a semiconductor constituting a TFT is preferably any of materials obtained by performing laser annealing on an oxide semiconductor, a low temperature polysilicon, and amorphous silicon. Regarding such semiconductors:
1. A material obtained by performing simple laser annealing on amorphous silicon has a mobility about 2 times or more that of a general purpose amorphous silicon.
2. An oxide semiconductor (for example, In—Ga—Zn—O) has a mobility about 5 times or more that of a general purpose amorphous silicon.
3. A low temperature polysilicon has a mobility about 10 times or more that of a general purpose amorphous silicon. Therefore, when such semiconductors are used, it is possible to prevent increase in the TFT size and prevent decrease in the aperture rate.

For two adjacent domains (for example, the first domain 31 and the second domain 32) in the pixel, at the boundary of the two domains, when the maximum brightness during white display of an area formed of the first domain 31 and the second domain 32 is set as 1, a ratio (W/d) of a width W of an area in which the brightness is 0.5 or less to the thickness d of the liquid crystal layer 13 is preferably 2.0 or less. W/d is more preferably 1.85 or less, and most preferably 1.50 or less in order to further improve the transmittance improvement effect.

The liquid crystal display 10 can be obtained by a method including the following process A and process B.
Process A: A liquid crystal alignment film (the first alignment film 22, and the second alignment film 23) is formed on an electrode disposition surface of each of the first substrate 11 and the second substrate 12 which have an electrode on their surfaces. In this case, at least one of the first substrate 11 and the second substrate 12 is subjected to alignment processing by performing light emission on a coating film formed using a liquid crystal alignment agent, and thus a plurality of alignment areas having different alignment directions of liquid crystal molecules are formed in one pixel.
Process B: The first substrate 11 and the second substrate 12 obtained in the process A are separated from each other with the liquid crystal layer 13 containing liquid crystal molecules having negative dielectric anisotropy located therebetween, and respective liquid crystal alignment films (the first alignment film 22 and the second alignment film 23) are disposed to face each other to form a liquid crystal cell.

The spacer 24 provided in the liquid crystal display 10 is preferably formed of a radiation-sensitive resin composition containing an oxime ester type polymerization initiator. In order to obtain a sufficient transmittance improvement effect, it is preferable that the thickness d of the liquid crystal layer 13 be maintained at 2.9 μm or less, and therefore the height of the spacer 24 needs to be uniform. In this regard, when a radiation-sensitive resin composition used for photolithography when a spacer is formed contains an oxime ester type polymerization initiator, it is possible to obtain the spacer 24 with a uniform height and thus an effect of improving the transmittance can be further enhanced.

Here, in the radiation-sensitive resin composition used for photolithography when a spacer is formed, a black coloring material such as a black pigment, a black dye, and carbon black may be included. When a spacer containing such a black coloring material is formed, an effect of reducing display defects due to light leakage between pixels of a liquid crystal display panel is obtained.

Specific examples of an oxime ester type polymerization initiator include O-acyloxime compounds, such as for example,
ethanone-1-[9-ethyl-6-(2-methylbenzoyl)-9H-carbazol-3-yl]-1-(O-acetyloxime),
1,2-octanedione-1-[4-(phenylthio)-2-(O-benzoyloxime)],
1-[9-ethyl-6-benzoyl-9H-carbazol-3-yl]-octan-1-one oxime-O-acetate,
1-[9-ethyl-6-(2-methylbenzoyl)-9H-carbazol-3-yl]-ethan-1-one oxime-O-benzoate,
1-[9-n-butyl-6-(2-ethylbenzoyl)-9H-carbazol-3-yl]-ethan-1-one oxime-O-benzoate,
ethanone-1-[9-ethyl-6-(2-methyl-4-tetrahydrofuranylbenzoyl)-9H-carbazol-3-yl]-1-(O-acetyloxime),
ethanone-1-[9-ethyl-6-(2-methyl-4-tetrahydropyranylbenzoyl)-9H-carbazol-3-yl]-1-(O-acetyloxime),
ethanone-1-[9-ethyl-6-(2-methyl-5-tetrahydrofuranylbenzoyl)-9H-carbazol-3-yl]-1-(O-acetyloxime), and
ethanone-1-[9-ethyl-6-{2-methyl-4-(2,2-dimethyl-1,3-dioxolanyl)methoxybenzoyl}-9H-carbazol-3-yl]-1-(O-acetyloxime). Among these, regarding oxime ester compounds,
ethanone-1-[9-ethyl-6-(2-methylbenzoyl)-9H-carbazol-3-yl]-1-(O-acetyloxime),
1,2-octanedione-1-[4-(phenylthio)-2-(O-benzoyloxime)],
ethanone-1-[9-ethyl-6-(2-methyl-4-tetrahydrofuranylmethoxybenzoyl)-9H-carbazol-3-yl]-1-(O-acetyloxime), and
ethanone-1-[9-ethyl-6-{2-methyl-4-(2,2-dimethyl-1,3-dioxolanyl)methoxybenzoyl}-9H-carbazol-3-yl]-1-(O-acetyloxime) are preferable.

In addition, oxime ester type polymerization initiators described in PCT International Publication No. WO 2010/102502, Japanese Unexamined Patent Application Publication No. 2008-78678, Japanese Unexamined Patent Application Publication No. 2008-78686, Japanese Unexamined Patent Application Publication No. 2011-132215, Japanese Unexamined Patent Application Publication No. 2012-132558, Japanese Unexamined Patent Application Publication No. 2015-152153, Japanese Unexamined Patent Application Publication No. 2015-93842, and the like can be used.

Regarding the radiation-sensitive resin composition containing an oxime ester type polymerization initiator, radiation-sensitive resin compositions described in, for example, Japanese Unexamined Patent Application Publication No. 2005-227525, Japanese Unexamined Patent Application Publication No. 2005-234362, and Japanese Unexamined Patent Application Publication No. 2006-30809 can be used.

Regarding a black coloring material such as a black pigment, a black dye, and carbon black, for example, colorants described in Japanese Unexamined Patent Application Publication No. 2007-249113, and Japanese Unexamined Patent Application Publication No. 2015-69181 can be used.

Next, examples of the liquid crystal display 10 according to the first embodiment will be described.

### EXAMPLE 1

The liquid crystal display 10 corresponding to FIG. 1 was produced. Two transparent glass substrates 14 and 16 having a thickness of 0.7 mm were prepared, and a plurality of band-like transparent electrodes (the pixel electrodes 15) made of ITO were provided in a stripe form on one glass substrate (the glass substrate 14). Here, band electrodes having periods of three types (α in FIG. 1) including 248, 124, and 62 μm were prepared. The electrode gaps 26 as a distance between electrodes were all 6 μm. That is, respective electrode widths (β in FIG. 1) were 242, 118, and 56 μm. Here, the numerical value (248, 124, and 62 μm) of the period of band electrodes is a value corresponding to the width of one pixel of 65 type in each of 4K, and 8K full high-definition televisions (FHD), which is a standard of pixel definition of televisions.

On the other glass substrate (the glass substrate 16), a plurality of band-like black matrices 17 (black resin) were provided. Here, like the first substrate, band-like black matrices having periods of three types were prepared, and the widths (γ in FIG. 1) of the band-like black matrices were all 12 μm. In addition, the entire surface of the substrate was covered with ITO, and a transparent electrode (the counter electrode 19) was provided. Then, columnar projections (the spacer 24) formed of a radiation-sensitive resin composition were provided at positions corresponding to the band-like black matrices. The size of the columnar projection was 10 μm square, and the height thereof was adjusted so that the thickness d of the liquid crystal layer 13 became a desired value of each of the following samples.

Regarding the radiation-sensitive resin composition for forming a spacer, a resin composition prepared as follows was used. In addition, a spacer formation performance of the radiation-sensitive resin composition used for spacer formation was evaluated.

### (Synthesis of Alkali-Soluble Resin)

5 parts by mass of 2,2′-azobis-(2,4-dimethyl valeronitrile) and 220 parts by mass of diethylene glycol methyl ethyl ether were put into a flask including a cooling pipe and a stirrer, and continuously, 12 parts by mass of methacrylic acid, 40 parts by mass of glycidyl methacrylate, 20 parts by mass of styrene, and 28 parts by mass of methacrylic acid tricyclo[5.2.1.0^{2,6}]decan-8-yl were put thereinto, purging with nitrogen was performed, the temperature of the solution increased to 70° C. while stirring gently, the temperature was maintained for 5 hours for polymerization, and the solution containing a copolymer (A-1) was obtained (solid content concentration=31.3%). The copolymer (A-1) had Mw=12,000.

### (Preparation of the Radiation-Sensitive Resin Composition)

100 parts by mass in terms of a solid content of the copolymer (A-1) obtained above, 100 parts by mass of a mixture containing dipentaerythritol pentaacrylate and dipentaerythritol hexaacrylate as a polymerizable compound (KAYARAD DPHA, commercially available from Nippon Kayaku Co., Ltd.), and 5 parts by mass of ethanone-1-[9-ethyl-6-(2-methylbenzoyl)-9H-carbazol-3-yl]-1-(O-acetyloxime) (Irgacure OXE02, commercially available from BASF) as an oxime ester type polymerization initiator were mixed together, and propylene glycol monomethyl ether acetate was added thereto so that a solid content concentration was 30 mass %, and the mixture was then filtered with a Millipore filter with a pore diameter of 0.5 μm, and thereby a radiation-sensitive resin composition containing an oxime ester type polymerization initiator was prepared.

### (Evaluation of Spacer Height)

The radiation-sensitive resin composition prepared above was applied to the glass substrate using a spinner and then pre-baked on a hot plate at 100° C. for 2 minutes, and thereby a coating film with a film thickness of 3.0 μm was formed. Next, the obtained coating film was irradiated with radiation at an exposure dose of 500 J/m² using a high pressure mercury lamp through a photomask having round residual patterns with different sizes in a range of a diameter of 20 μm. Then, shower development was performed by discharging a 0.40 mass % potassium hydroxide aqueous solution as a developing solution at 23° C., at a development pressure of 1 kgf/cm² and a nozzle diameter of 1 mm, and washing with pure water was performed for 1 minute. In addition, post-baking was performed in an oven at 230° C. for 30 minutes, and thereby spacer patterns were formed. The height of the spacer was measured using a laser microscope (VK-8500, Keyence Corporation). In this case, it was confirmed that the difference between heights of a plurality of spacers was within 3%, and the heights of the spacers could be made uniform.

Next, the liquid crystal alignment agent was applied to an electrode disposition surface of each of the first substrate 11 including the glass substrate 14 and the pixel electrode 15 and the second substrate 12 including the black matrix 17 and the counter electrode 19 by a spin cast method. The resultant was heated (pre-baked) on a hot plate at 80° C. and thus the entire solvent contained in the liquid crystal alignment agent was volatilized, and heating (post baking) was then performed in an oven at 200° C. for 40 minutes. Here, the final film thickness was 100 nm.

The photo-alignment film material (liquid crystal alignment agent) was prepared as follows.

### <Liquid Crystal Alignment Agent>

4.5 g of 2,3,5-tricarboxycyclopentylacetic acid dianhydride, 9.92 g of a compound represented by the following Formula (d-1), and 0.53 g of cholestanyl 3,5-diaminobenzoate were dissolved in 2,100 g of a solution in which N-methyl-2-pyrrolidone 230 g and γ-butyrolactone were mixed, and reacted at 40° C. for 3 hours, and 1,350 g of γ-butyrolactone was then added thereto, and thereby a solution containing a 10 mass % polyamic acid was obtained. This was used as a liquid crystal alignment agent.

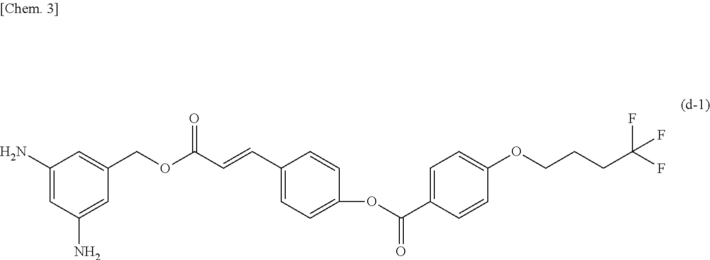 [SMILES: Nc1cc(N)cc(COC(=O)/C=C/c2ccc(OC(=O)c3ccc(OCCCC(F)(F)F)cc3)cc2)c1]

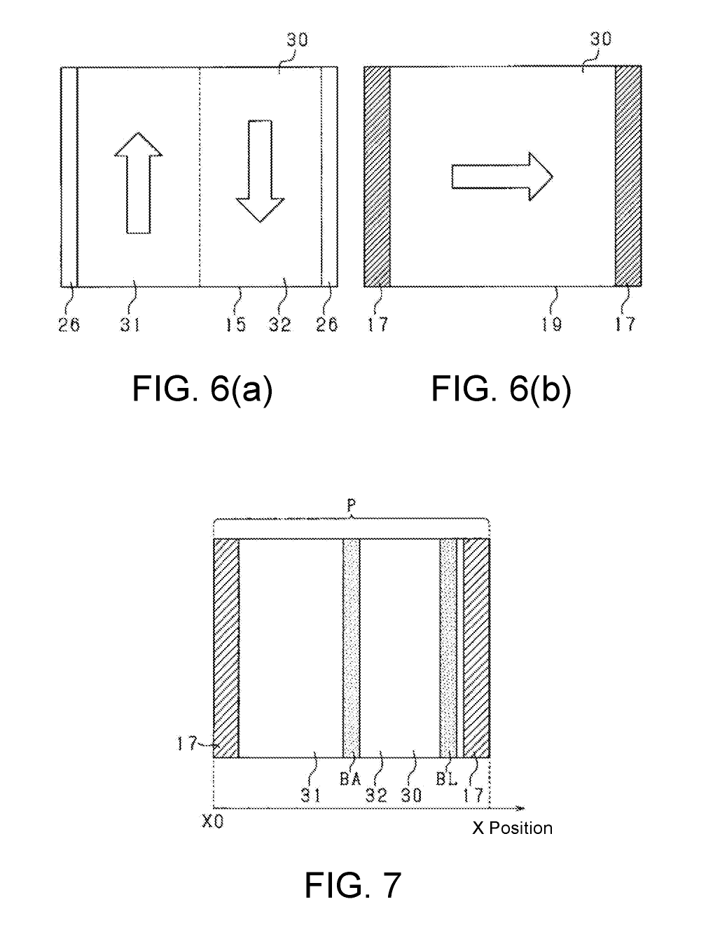

Next, for each of the first substrate 11 and the second substrate 12, polarized ultraviolet light was emitted at an angle of incidence of 40 degrees to the coating film surface formed using the liquid crystal alignment agent. Here, the wavelength of light was 313 nm, the irradiation energy was 40 mJ/cm², and the polarization state was P polarization. In this example, as 2 division alignments, the first domain 31 and the second domain 32 were formed in one pixel. Specifically, the incident direction of the first substrate 11 was parallel to a band direction of the electrode 15, and a boundary was provided at the center of the band electrode and the center of the electrode gap 26, and light was emitted in two directions antiparallel to each other between adjacent areas (refer to FIG. 6(a)). Here, such radiation was achieved by covering areas different in incident directions with a photomask in two steps. The incident direction of the second substrate 12 was orthogonal to the band direction of the black matrix 17. (refer to FIG. 6(b)). Arrows in FIG. 6 indicate the incident direction.

A thermosetting epoxy resin as the sealing material 25 was disposed at the outer edge of the second substrate 12 obtained in this manner. Then, surfaces of the photo-alignment films of the first substrate 11 and the second substrate 12 were bonded so that they became the inside. In this case, alignment was performed so that the center of the electrode gap 26 of a band-like ITO of the first substrate 11 and the center of the band-like black matrix 17 of the second substrate 12 were aligned. Next, heating was performed at 130° C. for 1 hour, and the epoxy resin was cured to obtain an empty cell.

Next, a nematic liquid crystal having negative dielectric anisotropy was prepared, and the liquid crystal was sealed in an empty cell by a vacuum injection method to obtain a liquid crystal cell. In the liquid crystal, the liquid crystal composition was adjusted so that the retardation (d·Δn) which is a product of the refractive index anisotropy Δn (=Ne−No) which is a difference between the refractive index No of the liquid crystal for ordinary light and the refractive index Ne for extraordinary light and the thickness (d) of the liquid crystal layer 13 was always 320 nm. The pretilt angle θ of the obtained liquid crystal cell was 89.0 degrees on both the first substrate 11 and the second substrate 12. Here, the pretilt angle θ is a value measured using an OPTI-Pro (commercially available from Syntek Co., Ltd.) (the same below). The measurement wavelength of the refractive index anisotropy Δn was 546 nm (the same below).

Regarding the obtained liquid crystal cell, electrodes of the first substrate 11 and the second substrate 12 were connected to a power supply, and the liquid crystal was made to respond by an electric field in the direction normal to the substrate. Here, a signal voltage was ±8 V, 60 Hz square wave. The liquid crystal cell was observed using a polarization microscope under cross Nicols. Here, the polarizing axis of the analyzer of the polarization microscope was aligned with the band direction of the electrode of the first substrate 11. As a result, although the field was a dark field at ±0 V, the field became a bright field when ±8 V was applied. FIG. 7 is a diagram schematically showing a display state of an observation area P (refer to FIG. 1) when a liquid crystal cell during white display is observed from the front. The first domain 31 and the second domain 32 having different alignment directions were formed in a pixel. In the bright field, a space between two adjacent black matrices 17 became bright, a dark line BA was generated in an intermediate part between the black matrices 17, and a dark line BL was generated at one end between the black matrices 17. These dark lines BA and BL extended in the band direction of the black matrix 17.

### Transmittance Evaluation 1

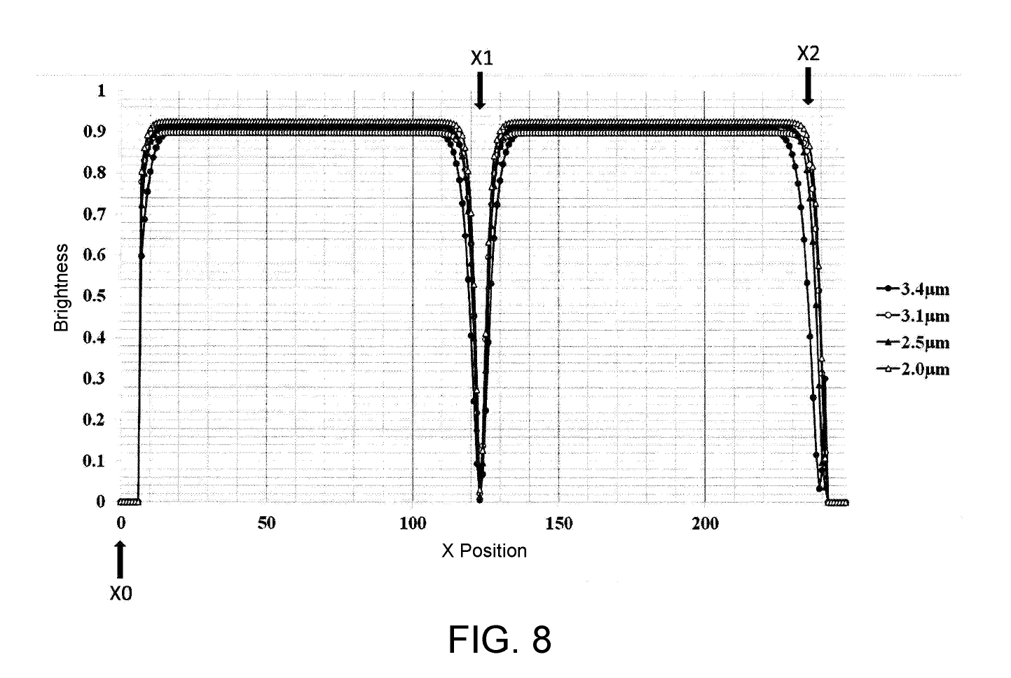

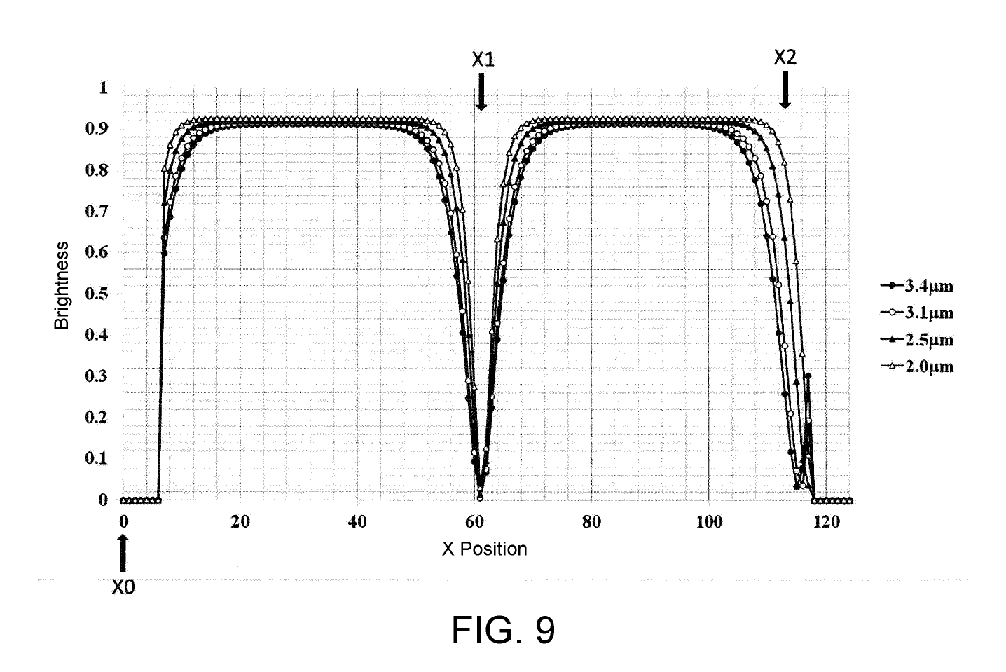

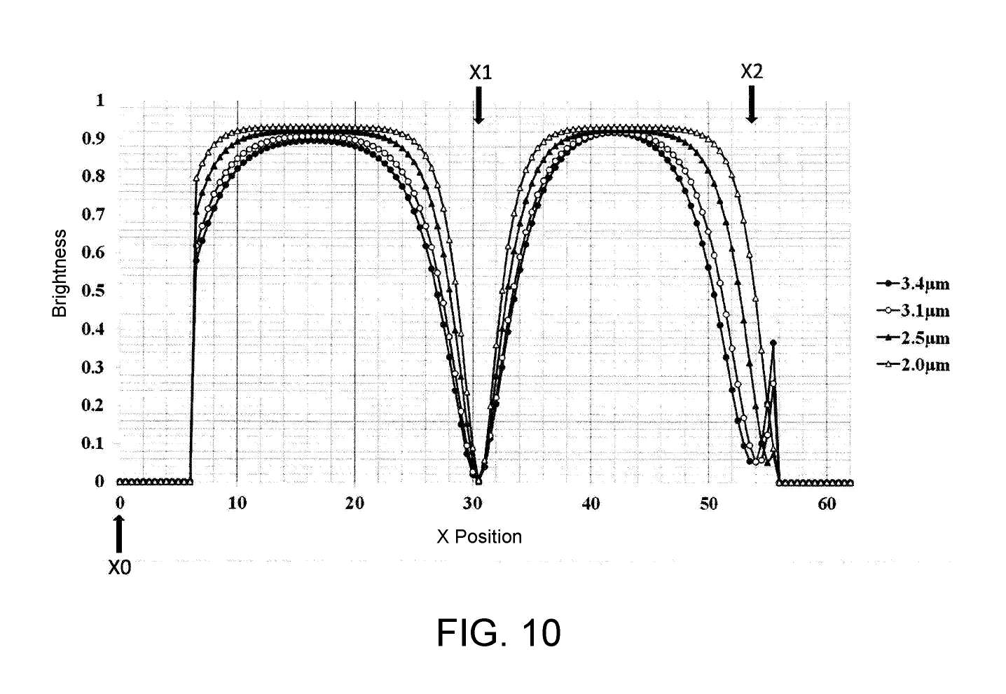

FIGS. 8 to 10 are diagrams showing the relationship between the thickness d of the liquid crystal layer 13 and the dark line width δ in the observation area P. FIG. 8 shows a case in which the pixel width was 248 μm, FIG. 9 shows a case in which the pixel width was 124 μm, and FIG. 10 shows a case in which the pixel width was 62 μm. In the observation area P, one end side of the band electrode in the width direction was set as a reference position X0, the horizontal axis in FIGS. 8 to 10 represents a position (X position) from the reference position X0 in the width direction, and the vertical axis represents the brightness. Here, in FIGS. 8 to 10, the brightness “1” is a brightness when two polarizing plates were disposed parallel to each other in the polarization direction, and the brightness “0” is a brightness when two polarizing plates were disposed orthogonal to each other in the polarization direction.

FIGS. 8 to 10 show results of the brightness of pixel areas during white display obtained by performing a simulation on liquid crystal cells having different thicknesses d of the liquid crystal layer 13. The thickness d was 2.5 μm in Example 1-1, and 2.0 μm in Example 1-2. In addition, regarding comparative examples, the thickness d was d=3.4 μm (Comparative Example 1-1), and d=3.1 μm (Comparative Example 1-2). The brightness was calculated using a liquid crystal simulator “LCD Master” (commercially available from Syntek Co., Ltd.) (the same as in the following examples). In the “LCD Master,” liquid crystal parameters were set as follows: elastic constant K1=16 pN (Pico Newton), K2=5 pN, K3=17.5 pN, specific dielectric constant ε//=3.5, and ε⊥=7.2. In addition, the voltage in an on state (white display) was 8 V. Regarding Δn, Δn was changed according to the thickness d so that the retardation (d·Δn) became 320 nm.

Based on the results in FIGS. 8 to 10, it could be clearly seen that, when the thickness d of the liquid crystal layer 13 was reduced, dark line widths at an intermediate part X1 between the black matrices 17 and an end X2 became thinner. In addition, it was confirmed that, when the pixel width was smaller, an effect of the dark line width narrowing due to the reduced thickness d appeared more significantly.

### Transmittance Evaluation 2

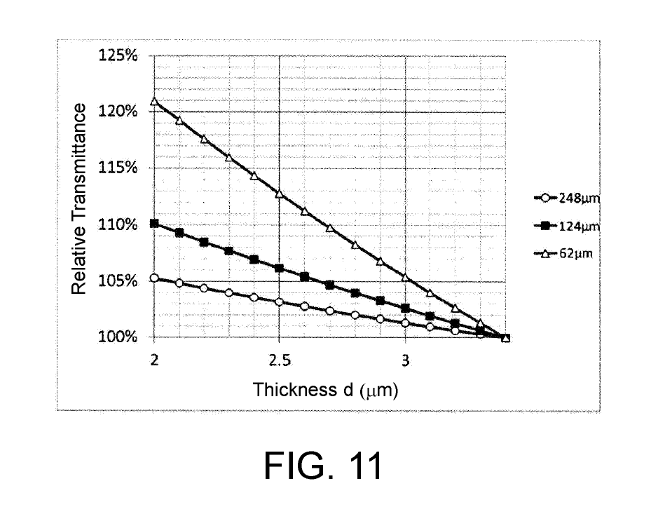

The inventors conducted studies and found that, in many liquid crystal televisions put into practical use, the thickness d of the liquid crystal layer 13 was 3.4 μm. Therefore, regarding the cross section light intensity (transmittance) of the liquid crystal cell, the transmittance was set as 100% when the thickness d of the liquid crystal layer 13 was 3.4 μm (Comparative Example 1-1), and the relative transmittance when the thickness d was changed was measured by a liquid crystal simulator. The results are shown in the following Table 1. In addition, FIG. 11 shows results in which data in Table 1 is plotted. Here, three liquid crystal cells (pixel width=248 μm, 124 μm, 62 μm) with different pixel widths were examined.

TABLE 1

| Thickness d | | | |
|---|---|---|---|
| (μm) | 248 μm | 124 μm | 62 μm |
| 3.4 | 100.00% | 100.00% | 100.00% |
| 3.3 | 100.31% | 100.63% | 101.30% |
| 3.2 | 100.63% | 101.27% | 102.63% |
| 3.1 | 100.95% | 101.93% | 103.99% |
| 3 | 101.29% | 102.60% | 105.38% |
| 2.9 | 101.64% | 103.29% | 106.80% |
| 2.8 | 102.00% | 103.99% | 108.25% |
| 2.7 | 102.37% | 104.70% | 109.73% |
| 2.6 | 102.76% | 105.43% | 111.24% |
| 2.5 | 103.15% | 106.17% | 112.78% |
| 2.4 | 103.55% | 106.93% | 114.34% |
| 2.3 | 103.96% | 107.70% | 115.94% |
| 2.2 | 104.39% | 108.48% | 117.57% |
| 2.1 | 104.82% | 109.28% | 119.23% |
| 2.0 | 105.27% | 110.09% | 120.91% |

Based on the results shown in FIG. 11, it could be clearly seen that the relative transmittance can be improved by reducing the thickness d of the liquid crystal layer 13. In addition, in consideration of the results in FIGS. 8 to 10 together, it can be said that, when the thickness d of the liquid crystal layer 13 was smaller, the dark line width δ was narrowed, and the narrowed dark line width δ influenced improvement in the relative transmittance.

In addition, it can be understood in FIG. 11 that, when the pixel width was reduced, a significant transmittance improvement effect appeared as the thickness d was thinner. Specifically, when the thickness d of the liquid crystal layer 13 was 2.9 μm or less, clear transmittance improvement was confirmed as follows: a transmittance of 1% or more for a liquid crystal display having a pixel width of 248 μm, a transmittance of 3% or more for a liquid crystal display having a pixel width of 124 μm, and a transmittance of 6% or more for a liquid crystal display having a pixel width of 62 μm. In particular, when the pixel width was 2.7 μm or less, a transmittance improvement effect was found as follow: a transmittance of 2% or more for a liquid crystal display having a pixel width of 248 μm, a transmittance of 4% or more for a liquid crystal display having a pixel width of 124 μm, and a transmittance of 9% or more for a liquid crystal display having a pixel width of 62 μm. In addition, when the pixel width was 2.5 μm or less, a transmittance improvement effect was found as follows: a transmittance of 3% or more for a liquid crystal display having a pixel width of 248 μm, a transmittance of 6% or more for a liquid crystal display having a pixel width of 124 μm, and a transmittance of 12% or more for a liquid crystal display having a pixel width of 62 μm.

This is, when the pixel size was smaller, since a proportion of the pixel area 30 occupied by dark lines was relatively larger, this was thought to contribute greatly to increasing the narrowing of the dark lines. In recent high-definition liquid crystal displays constituted with pixels with a very small size and with a pixel width of 62 μm or 124 μm, since a proportion occupied by the black matrix 17 in each pixel is relatively high, the transmittance tends to be lower than that of a conventional liquid crystal display having a relatively large pixel width. Therefore, a practical value of improvement in the transmittance of the liquid crystal display 10 by reducing the thickness d of the liquid crystal layer 13 is thought to be large.

Here, while a transmittance improvement effect was confirmed in this example in which alignment divisions in the pixel were 2 domains, even if there were 4 or more domains, this was effective because an effect of the dark line narrowing at a boundary part between alignment divisions and the dark line near the electrode end was obtained. When the number of domains increased, since the number of boundaries increased, a proportion of occupied by dark lines in the pixel relatively increased. Therefore, this was suitable because a transmittance improvement effect due to the narrowed dark lines more appeared significantly.

### EXAMPLE 2

The inventors constructed a hypothesis in which the dark line width δ appearing in the boundary part of alignment divisions was caused by misalignment of liquid crystal, and the dark line width δ was determined by the size of the area in which misalignment occurred, that is, the size of liquid crystal alignment deformation, and varied in a manner similar to the size of the liquid crystal alignment deformation. According to this hypothesis, it was speculated that, when the thickness d of the liquid crystal layer 13 was made thin, the size of the liquid crystal alignment deformation was reduced due to the influence of liquid crystal continuous deformation, and thus the result that the dark line width δ was narrowed was obtained. In this case, it was thought that the dark line width δ varied in a manner similar to that of the thickness d of the liquid crystal layer 13. Thus, in this example, the relationship between the thickness d of the liquid crystal layer 13 and the dark line width δ was determined.

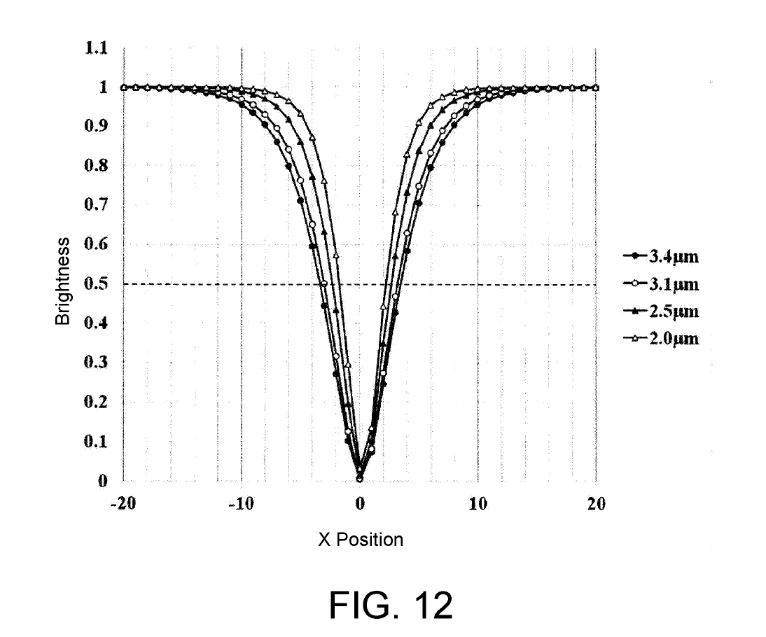

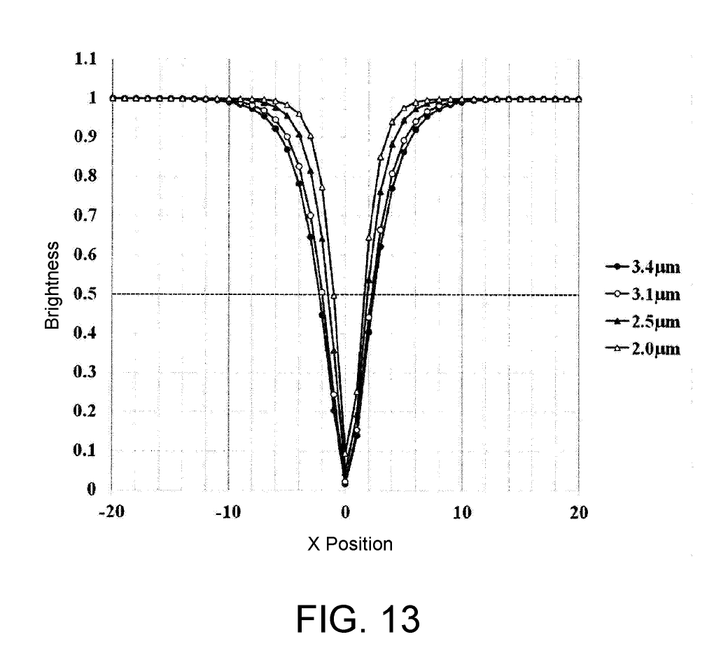

FIG. 12 and FIG. 13 show simulation results of the relationship between the position (X position) in the electrode width direction and the brightness for each observation area P. For the liquid crystal display 10, the same device as in Example 1 was used. Here, in the horizontal axis in FIGS. 12 and 13, the position of the boundary of the alignment division was set as 0, and the position in the left direction with respect to the position of the boundary is indicated by “−” and the position in the right direction is indicated by “+.” The vertical axis represents the brightness when the maximum brightness during white display of the pixel area 30 (an area formed of the first domain 31 and the second domain 32 in FIG. 7) in the observation area P was set as “1.” FIG. 12 shows a case in which the pretilt angle θ was 89.0 degrees, and FIG. 13 shows a case in which the pretilt angle θ was 88.0 degrees. The pixel width was 248 μm. The pretilt angle was the same for the first alignment film 22 and the second alignment film 23.

As can be seen from FIG. 12 and FIG. 13, during white display, the brightness was minimized at the boundary position of the alignment division, and the brightness gradually increased laterally symmetrically away from the boundary position. In addition, it was confirmed that, when the thickness d of the liquid crystal layer 13 was thinner, the rise of the brightness from the boundary position was sharper, and the dark line width was narrower. In addition, comparing FIG. 12 and FIG. 13, it was confirmed that, when the pretilt angle θ was smaller, the rise of the brightness from the boundary position became sharper, and the dark line width was narrowed.

In addition, while the dark line width when the pixel width was 124 μm was checked in the same manner, the result was the same as when the pixel width was 248 μm. This is thought to be caused by the fact that the dark line width at the boundary of the alignment division did not influence the pixel width as long as the influence of the pixel end did not reach it.

Based on data in FIG. 12 and FIG. 13, a width of an area extending in the length direction of the boundary and having a brightness of 0.5 or less was defined as a dark line width W, and a ratio (W/d) of the dark line width W to the thickness d of the liquid crystal layer 13 was obtained. The results are shown in the following Table 2 and Table 3. Here, Table 2 shows the results obtained when the pretilt angle θ was 89 degrees, and Table 3 shows the results obtained when the pretilt angle θ was 88 degrees. In Table 2 and Table 3, “left 50%” represents the X position in the left direction at which the brightness was 0.5 and “right 50%” represents the X position in the right direction at which the brightness was 0.5.

TABLE 2

| | | | | |
|---|---|---|---|---|
| d (μm) | 3.4 | 3.1 | 2.5 | 2.0 |
| Left 50% | −3.37 | −3.06 | −2.33 | −1.73 |
| Right 50% | 3.46 | 3.19 | 2.68 | 2.23 |
| W (μm) | 6.83 | 6.26 | 5.00 | 3.97 |
| W/d | 2.01 | 2.02 | 2.00 | 1.98 |

TABLE 3

| | | | | |
|---|---|---|---|---|
| d (μm) | 3.4 | 3.1 | 2.5 | 2.0 |
| Left 50% | −2.26 | −1.97 | −1.50 | −1.01 |
| Right 50% | 2.44 | 2.26 | 1.89 | 1.63 |
| W (μm) | 4.71 | 4.24 | 3.39 | 2.64 |
| W/d | 1.38 | 1.37 | 1.36 | 1.32 |

Based on the results, it was confirmed that the thickness d of the liquid crystal layer 13 and the dark line width δ varied in substantially the same manner, and when the thickness d of the liquid crystal layer 13 was made thin, the dark line width δ was narrowed. In addition, when the thickness d was made thin, W/d decreased and a transmittance improvement effect became more significant. In order to further examine this point, W/d when the thickness d of the liquid crystal layer 13 was 2.9 μm, and the pretilt angle θ was 89 degrees, 88.5 degrees, 88.3 degrees, or 88.0 degrees was calculated, and the results were as small as 2.00, 1.84, 1.71, and 1.36. Therefore, it can be understood that a transmittance improvement effect more appeared significantly when the pretilt angle θ was smaller.

In the vertical alignment mode having a photo-alignment film, when the thickness d of the liquid crystal layer 13 was 2.9 μm or less, a transmittance improvement effect was obtained. On the other hand, in the other liquid crystal display mode, a transmittance improvement effect with the thickness d of the liquid crystal layer 13 set to 2.9 μm or less was not recognized. The reason for this is as follows.

### COMPARATIVE EXAMPLE 2

Polymer sustained alignment (PSA) mode:

When the thickness d of the liquid crystal layer was reduced, a width/gap of a fishbone electrode used in a PSA mode was relatively wider than the thickness d. Therefore, the uniformity in the alignment direction deteriorated and the transmittance greatly decreased. A phenomenon in which the dark line of the domain division was narrower when the thickness d was narrower was confirmed, but the decrease in transmittance derived from the fishbone electrode was larger, and a transmittance improvement effect as in the vertical alignment mode having a photo-alignment film was not obtained. In order to prevent decrease in the transmittance derived from the fishbone electrode, it is necessary to make a width/gap of the fishbone electrode narrower with a proportional ratio, but realization of this is difficult because fine patterning (photolithography) is difficult.

### COMPARATIVE EXAMPLES 3 and 4

Multi-domain vertical alignment (MVA) mode:
Patterned vertical alignment (PVA) mode:

In such modes, the alignment division was achieved in the structure. Therefore, the dark line width was derived from the size of the structure, and even if the thickness d of the liquid crystal layer 13 was thin, the dark line width of the domain division was not narrowed. If the structure was narrowed and the thickness d of the liquid crystal layer 13 was made thin, an alignment regulating force between structures was relatively lowered, and a poor response problem was caused. In order to prevent a poor response due to the reduction in the thickness d of the liquid crystal layer 13, it is necessary to narrow a distance between structures, and the transmittance is eventually lowered.

### COMPARATIVE EXAMPLES 5 and 6

In-plane switching (IPS) mode:
Fringe field switching (FFS) mode:

When the thickness d of the liquid crystal layer 13 was reduced, the dark line resulting from the domain division was narrowed, but a width/gap of the electrode for a horizontal electric field used in such a mode was relatively wider than the thickness d, and thus the transmittance was lowered. In order to prevent decrease in the transmittance derived from the electrode, it is necessary to make a width/gap of the electrode narrower with a proportional ratio, but realization is difficult because fine patterning (photolithography) is difficult.

Generally, it is known that, in the liquid crystal display, a response time related to a video display performance can be made faster by reducing the thickness d of the liquid crystal layer 13. However, as described above, in the above various display modes widely used for liquid crystal televisions, a disadvantage in which the transmittance is lowered by reducing the thickness d of the liquid crystal layer 13 was caused. On the other hand, it could be clearly seen that, in the vertical alignment mode having a photo-alignment film, it was possible to achieve both specifically a transmittance improvement effect being exhibited when the thickness d of the liquid crystal layer 13 was reduced and improvement in a response time.

### Second Embodiment

In a second embodiment, the transmittance improvement effect is obtained by setting the pretilt angle θ of the photo-alignment film to a predetermined value or less. In this case, the pretilt angle θ is less than 88.5 degrees, preferably less than 88.3 degrees, and more preferably less than 88.0 degrees. The lower limit value of the pretilt angle is not particularly limited, and is preferably 86.4 degrees or more and more preferably 87.1 degrees or more in order to obtain the liquid crystal display 10 having high transmittance. Here, the liquid crystal display 10 of the present embodiment is in a VATN mode as in the first embodiment. The description of the first embodiment is applied to the basic configuration of the liquid crystal display 10.

In the present embodiment, the thickness d of the liquid crystal layer 13 is not particularly limited, and is preferably 2.9 μm or less. When the thickness d of the liquid crystal layer 13 is narrowed and the pretilt angle θ is reduced, this is suitable because the dark line width δ can be further narrowed, and an effect of improving the transmittance can be further enhanced. Here, the description of the first embodiment is applied to description of the thickness d of the liquid crystal layer 13.

Next, examples of the liquid crystal display 10 of the second embodiment will be described.

### EXAMPLE 3

In this example, when the pretilt angle θ of the photo-alignment film was made smaller than 90 degrees, an effect of the dark line width narrowing was confirmed.

### Transmittance Evaluation 1

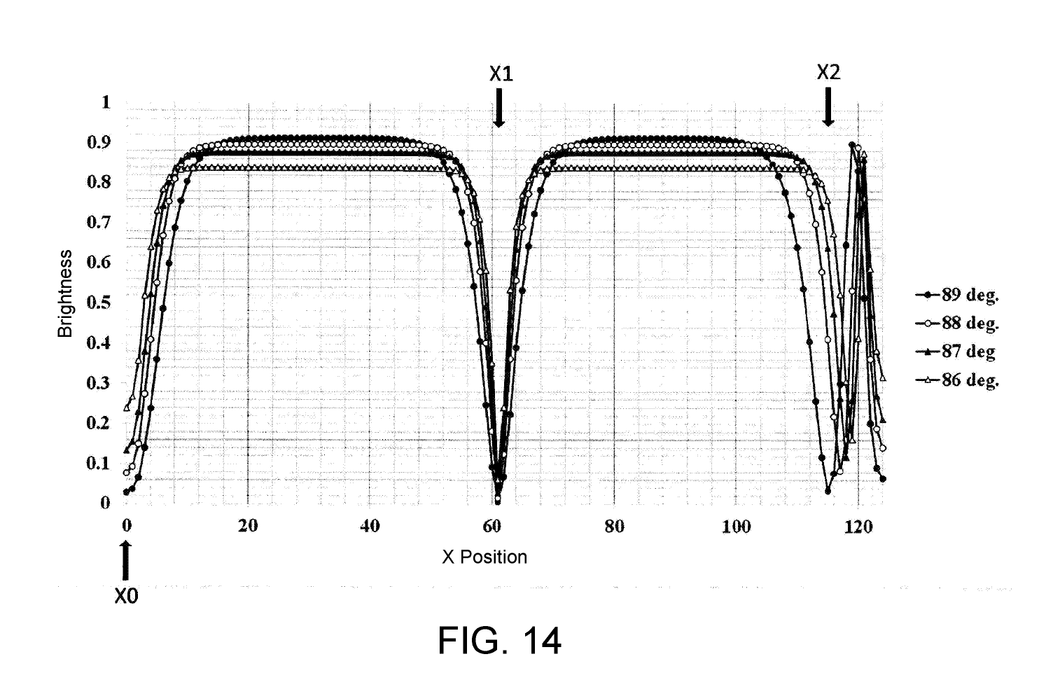

FIG. 14 is a diagram showing the relationship between the dark line width δ and the pretilt angle θ in the observation area P. In this example, four types of the liquid crystal display 10 having a pretilt angle θ of 89 degrees (Comparative Example 7-1), 88 degrees (Example 3-1), 87 degrees (Example 3-2), and 86 degrees (Example 3-3) were evaluated. Regarding the pretilt angle θ, for each polymer component in a photo-alignment film material, a blending ratio of polyamic acids having horizontal alignment properties was adjusted to obtain a pretilt angle θ with a desired value. The pretilt angle was the same as in the first alignment film 22 and the second alignment film 23. Here, in FIG. 14, in the liquid crystal display 10, the thickness d of the liquid crystal layer 13 was 3.4 μm, and the pixel width was 124 μm. The other parts were the same as in Example 1.

FIG. 14 shows simulation results of brightness of four types of liquid crystal cells having different pretilt angles θ (89 degrees, 88 degrees, 87 degrees, and 86 degrees) for each X position during white display. Here, the horizontal axis and the vertical axis in FIG. 14 are the same as in FIGS. 8 to 10. Based on the results in FIG. 14, it could be clearly seen that, when the pretilt angle θ was reduced, dark line widths at an intermediate part X1 between two adjacent black matrices 17 and an end X2 of the pixel electrode 15 became thinner. In addition, it was confirmed that, when the pretilt angle θ was reduced, the highest point of the brightness tended to decrease, and particularly, the highest point was largely reduced between 87 degrees and 86 degrees. Accordingly, it could be clearly seen that the pretilt angle θ is particularly preferably within a predetermined range in order to improve the transmittance of the liquid crystal display 10.

### Transmittance Evaluation 2

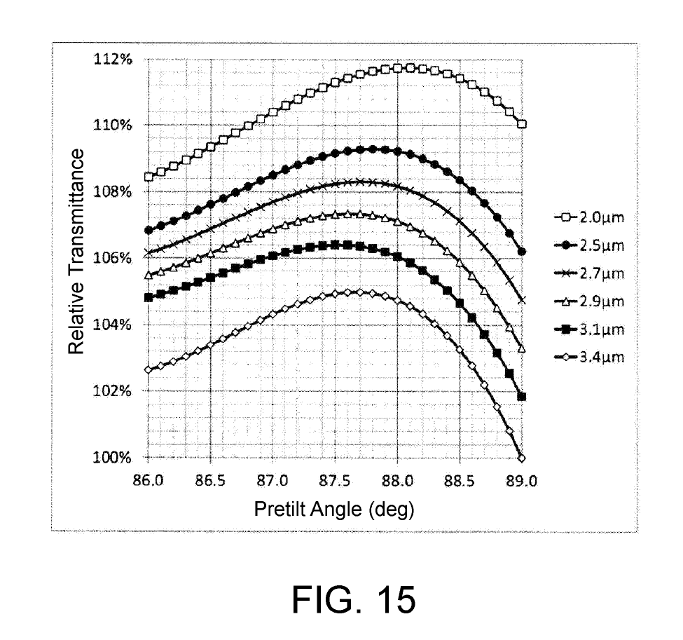

The inventors conducted studies and found that, in many liquid crystal televisions put into practical use using photo-alignment technology, the pretilt angle θ was about 89.0 degrees. Therefore, regarding the cross section light intensity (transmittance) of the liquid crystal cell, the transmittance was set as 100% when the pretilt angle was 89.0 degrees, and the thickness d of the liquid crystal layer 13 was 3.4 μm (Comparative Example 7-1), and the relative transmittance when the pretilt angle θ and the thickness d were changed was measured by a liquid crystal simulator. The results are shown in the following Table 4. In addition, FIG. 15 shows results in which data in Table 4 is plotted.

TABLE 4

| Pretilt angle | 3.4 μm | 3.1 μm | 2.9 μm | 2.7 μm | 2.5 μm | 2.0 μm |
|---|---|---|---|---|---|---|
| 89.0 | 100.00% | 101.85% | 103.30% | 104.76% | 106.21% | 110.05% |
| 88.9 | 100.82% | 102.54% | 103.94% | 105.35% | 106.76% | 110.43% |
| 88.8 | 101.55% | 103.16% | 104.52% | 105.88% | 107.24% | 110.75% |
| 88.7 | 102.20% | 103.72% | 105.04% | 106.35% | 107.67% | 111.02% |
| 88.6 | 102.77% | 104.22% | 105.49% | 106.76% | 108.04% | 111.25% |
| 88.5 | 103.26% | 104.66% | 105.89% | 107.12% | 108.35% | 111.43% |
| 88.4 | 103.68% | 105.04% | 106.23% | 107.42% | 108.62% | 111.56% |
| 88.3 | 104.04% | 105.36% | 106.52% | 107.68% | 108.83% | 111.66% |
| 88.2 | 104.33% | 105.64% | 106.76% | 107.88% | 109.00% | 111.72% |
| 88.1 | 104.56% | 105.87% | 106.96% | 108.04% | 109.13% | 111.75% |
| 88.0 | 104.74% | 106.05% | 107.11% | 108.16% | 109.22% | 111.74% |
| 87.9 | 104.87% | 106.20% | 107.22% | 108.24% | 109.27% | 111.70% |
| 87.8 | 104.94% | 106.30% | 107.29% | 108.29% | 109.28% | 111.64% |
| 87.7 | 104.98% | 106.37% | 107.33% | 108.30% | 109.27% | 111.55% |
| 87.6 | 104.97% | 106.40% | 107.34% | 108.28% | 109.22% | 111.43% |
| 87.5 | 104.93% | 106.40% | 107.32% | 108.24% | 109.15% | 111.30% |
| 87.4 | 104.86% | 106.38% | 107.27% | 108.17% | 109.06% | 111.15% |
| 87.3 | 104.76% | 106.33% | 107.20% | 108.07% | 108.94% | 110.98% |
| 87.2 | 104.63% | 106.26% | 107.11% | 107.96% | 108.81% | 110.79% |
| 87.1 | 104.48% | 106.18% | 107.00% | 107.83% | 108.66% | 110.60% |
| 87.0 | 104.32% | 106.07% | 106.88% | 107.69% | 108.50% | 110.40% |
| 86.9 | 104.14% | 105.95% | 106.75% | 107.54% | 108.33% | 110.19% |
| 86.8 | 103.96% | 105.83% | 106.60% | 107.38% | 108.16% | 109.98% |
| 86.7 | 103.77% | 105.69% | 106.46% | 107.22% | 107.98% | 109.77% |
| 86.6 | 103.58% | 105.56% | 106.30% | 107.05% | 107.80% | 109.56% |
| 86.5 | 103.39% | 105.42% | 106.15% | 106.88% | 107.61% | 109.35% |
| 86.4 | 103.21% | 105.28% | 106.00% | 106.72% | 107.44% | 109.14% |
| 86.3 | 103.03% | 105.15% | 105.86% | 106.56% | 107.27% | 108.95% |
| 86.2 | 102.88% | 105.02% | 105.72% | 106.41% | 107.11% | 108.76% |
| 86.1 | 102.74% | 104.91% | 105.59% | 106.28% | 106.96% | 108.59% |
| 86.0 | 102.63% | 104.81% | 105.48% | 106.16% | 106.83% | 108.44% |

Based on the results shown in FIG. 15, it was confirmed that the relative transmittance can be improved by making the pretilt angle θ smaller than 89.0 degrees. In addition, in combination with results in FIG. 14, it could be clearly seen that, when the pretilt angle θ was smaller, the dark line width δ was narrowed, and the narrowed dark line width δ influenced improvement in the relative transmittance. Specifically, when the thickness d of the liquid crystal layer 13 was 3.4 μm, transmittance improvement was confirmed as follows: a transmittance of 3% or more for a liquid crystal display having a pretilt angle θ of 86.3 degrees or more and 88.5 degrees or less, a transmittance of 4% or more for a liquid crystal display having a pretilt angle θ of 86.9 degrees or more and 88.3 degrees or less, and a transmittance of 4.5% or more for a liquid crystal display having a pretilt angle θ of 87.2 degrees or more and 88.1 degrees or less.

In addition, based on the results in FIG. 15, it can be understood that a relative transmittance improvement effect varied according to the thickness d of the liquid crystal layer 13, and the relative transmittance can be further improved by reducing the thickness d. Specifically, when the thickness d of the liquid crystal layer 13 was 2.9 μm, clear transmittance improvement was confirmed as follows: a transmittance of 5% or more for a liquid crystal display having a pretilt angle θ of 88.7 degrees or less, a transmittance of 6% or more for a liquid crystal display having a pretilt angle θ of 86.4 degrees or more and 88.4 degrees or less, and a transmittance of 7% or more for a liquid crystal display having a pretilt angle θ of 87.1 degrees or more and 88.0 degrees or less. In addition, when the thickness d of the liquid crystal layer 13 was made even smaller than 2.9 μm, a further improvement effect was observed.

Here, based on the results in FIG. 15, it can be understood that, when the pretilt angle θ was reduced, the dark line width was narrowed, but the highest point of the relative transmittance decreased, and thus the pretilt angle θ was particularly preferably a predetermined lower limit value or more. Considering the reason for provision of the lower limit value in more detail, it can be inferred that, since this mode had a structure in which alignment directions of substrates are orthogonal to each other, when the pretilt angle θ was reduced, optical properties thereof changed from a birefringence type to an optical rotation type, and a required retardation value was insufficient at 320 nm.

### EXAMPLE 4

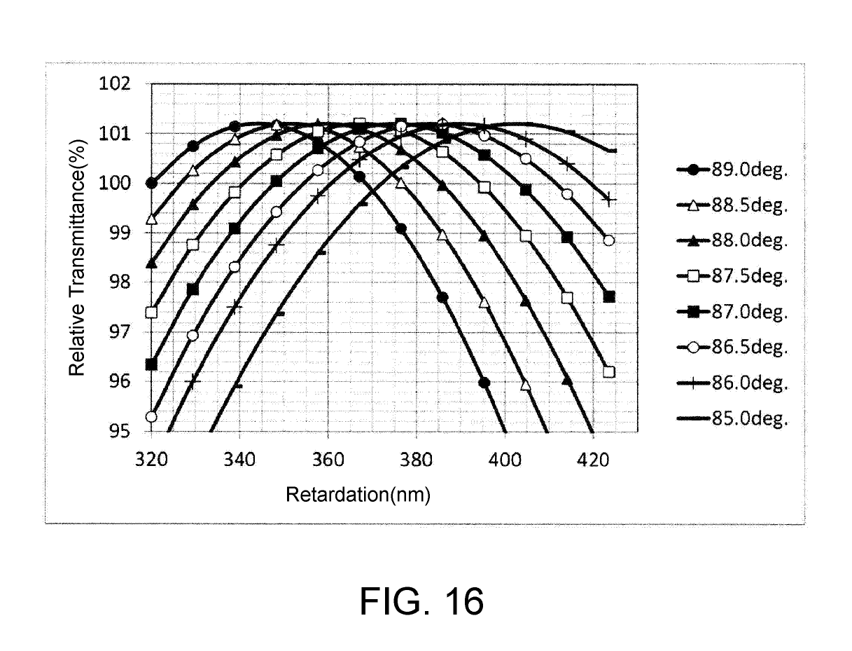

It was clearly found in Example 3 that, when the pretilt angle θ was reduced, the highest point of the relative transmittance decreased. Thus, it was speculated that the retardation value was insufficient at 320 nm. Therefore, the retardation value was changed at each pretilt angle and it was examined how the highest point of the transmittance changed. The following Table 5 shows the results obtained when the value of the highest point of the transmittance was set as 100% when the pretilt angle of the photo-alignment film (the first alignment film 22 and the second alignment film 23) was 89.0 degrees, and the retardation value was 320 nm, and the highest point of the transmittance when the pretilt angle (deg.) and the retardation value (nm) were changed was represented by a relative value (relative transmittance (%)). In addition, FIG. 16 shows results in which data in Table 5 is plotted.

TABLE 5

| Ret. (nm) | 89.0 deg. | 88.5 deg. | 88.0 deg. | 87.5 deg. | 87.0 deg. | 86.5 deg. | 86.0 deg. | 85.0 deg. |
|---|---|---|---|---|---|---|---|---|
| 320.00 | 100.00 | 99.29 | 98.39 | 97.39 | 96.34 | 95.28 | 94.24 | 92.30 |
| 329.41 | 100.75 | 100.26 | 99.57 | 98.75 | 97.86 | 96.93 | 96.00 | 94.22 |
| 338.82 | 101.14 | 100.89 | 100.43 | 99.82 | 99.09 | 98.31 | 97.50 | 95.91 |
| 348.24 | 101.17 | 101.18 | 100.98 | 100.58 | 100.05 | 99.42 | 98.75 | 97.37 |
| 357.65 | 100.83 | 101.13 | 101.20 | 101.04 | 100.71 | 100.27 | 99.74 | 98.59 |
| 367.06 | 100.14 | 100.74 | 101.10 | 101.20 | 101.10 | 100.84 | 100.48 | 99.58 |
| 376.47 | 99.09 | 100.02 | 100.69 | 101.07 | 101.20 | 101.15 | 100.96 | 100.33 |
| 385.88 | 97.70 | 98.97 | 99.97 | 100.64 | 101.03 | 101.19 | 101.18 | 100.85 |
| 395.29 | 95.99 | 97.61 | 98.95 | 99.93 | 100.58 | 100.97 | 101.16 | 101.14 |
| 404.71 | 93.95 | 95.95 | 97.64 | 98.94 | 99.87 | 100.50 | 100.90 | 101.20 |
| 414.12 | 91.62 | 94.00 | 96.07 | 97.70 | 98.91 | 99.79 | 100.40 | 101.04 |
| 423.53 | 89.01 | 91.79 | 94.23 | 96.20 | 97.72 | 98.85 | 99.68 | 100.67 |
| | | | | | | | | (%) |

Based on the results shown in Table 5 and FIG. 16, it can be understood that, when the pretilt angle θ was reduced, the transmittance can be maintained by making the retardation value greater than 320 nm.

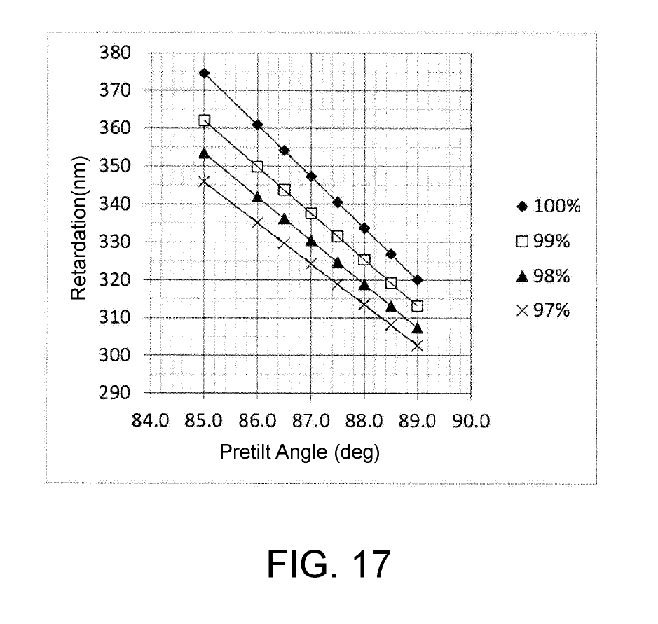

The following Table 6 shows the results obtained when the obtained data was analyzed, and required retardation values for maintaining a transmittance of 97%, 98%, 99%, and 100% were calculated at each pretilt angle. In addition, FIG. 17 shows results in which data in Table 6 is plotted.

TABLE 6

| Tilt (deg.) | 100% | 99% | 98% | 97% |
|---|---|---|---|---|
| 89.0 | 320.0 | 313.1 | 307.4 | 302.7 |
| 88.5 | 326.8 | 319.3 | 313.1 | 308.1 |
| 88.0 | 333.7 | 325.4 | 318.9 | 313.5 |
| 87.5 | 340.5 | 331.5 | 324.7 | 318.9 |
| 87.0 | 347.3 | 337.6 | 330.4 | 324.3 |
| 86.5 | 354.1 | 343.7 | 336.2 | 329.7 |
| 86.0 | 360.9 | 349.9 | 341.9 | 335.1 |
| 85.0 | 374.5 | 362.1 | 353.4 | 345.9 |
| | | | | (nm) |

When the results in Table 6 were subjected to regression analysis, required retardation values for maintaining respective transmittances are represented by the following Formula (1) to Formula (4). Here, in the following Formula (1) to Formula (4), P is a pretilt angle (deg.) of the photo-alignment film, and R is a retardation value (nm).

97% transmittance: R=−10.806×P+1264.4 (1)

98% transmittance: R=−11.516×P+1332.3 (2)

99% transmittance: R=−12.24×P+1402.5 (3)

100% transmittance: R=−13.621×P+1532.3 (4)

Based on the results in Table 4, it can be understood that, when the pretilt angle was 88.5 degrees, the pretilt angle was 89.0 degrees, and on the other hand, since a transmittance improvement effect of 3.26% was obtained when the thickness d was 3.4 μm, if the retardation value was a value that satisfies at least Formula (1) or more, a transmittance improvement effect of over 100% in total was obtained. In addition, a retardation value that satisfies Formula (2) or more was more preferable in order to improve the transmittance. In addition, if the retardation value was a value that satisfies Formula (3) or more, this is preferable because the transmittance was 99% or more, a value equivalent to the highest point of the transmittance when the pretilt angle was 89.0 degrees, and the retardation value was 320 nm could be realized. In addition, if the retardation value was a value that satisfies Formula (4) or more, this is more preferable because a transmittance equal to or higher than the highest point of the transmittance when the pretilt angle was 89.0 degrees and the retardation value was 320 nm can be secured.

### Third Embodiment

A third embodiment is different from the first embodiment and the second embodiment in that photo-alignment processing was performed on the liquid crystal alignment film so that a projection direction of which a long axis direction of the liquid crystal molecules in the vicinity of the first alignment film 22 extends and a projection direction of which a long axis direction of the liquid crystal molecules in the vicinity of the second alignment film 23 extends are antiparallel to each other. This mode is also referred to as a vertical alignment electrically control birefringence (VAECB) mode. Here, the description of the embodiment is applied to description of the thickness d and the pretilt angle θ of the liquid crystal layer 13.

### EXAMPLE 5

In the 2-division domain in FIG. 6, photo-alignment processing was performed on the first substrate 11 so that an alignment direction of one area between two domains was at +45 degrees and an alignment direction of the other area was at −45 degrees with respect to the band direction of the electrode. In addition, in the same manner, the second substrate 12 was subjected to photo-alignment processing in two directions. However, areas of the second substrate 12 were irradiated with ultraviolet light so that their alignment directions were antiparallel to alignment directions of corresponding areas of the first substrate 11.

When the relative transmittance of the liquid crystal display 10 in a VAECB mode was evaluated in the same manner as in Example 1 and Example 3, the transmittance improvement effect was confirmed in the liquid crystal display 10 in a VAECB mode. Specifically, evaluation was performed in the same manner as in Example 1, the transmittance improvement was confirmed when the thickness of the liquid crystal layer was 2.9 μm or less, and the effect was confirmed preferably at 2.7 μm or less, and more preferably at 2.5 μm or less. In addition, regarding the pretilt angle θ, evaluation was performed in the same manner as in Example 3, the transmittance improvement was confirmed when the pretilt angle θ was less than 88.5 degrees, and the effect was confirmed preferably at less than 88.3 degrees, and more preferably less than 88.0 degrees. However, decrease in the transmittance when the pretilt angle θ was further reduced as in Example 3 was not confirmed. This is thought to be caused by the fact that, in this example, since alignment directions on the alignment film were not orthogonal to each other, even if the pretilt angle θ was reduced, optical rotation could not occur.

### Fourth Embodiment

A fourth embodiment is different from the first embodiment to the third embodiment in that photo-alignment processing was performed on the first alignment film 22 between the first alignment film 22 and the second alignment film 23, but photo-alignment processing was not performed on the second alignment film 23. In this embodiment, pretilt angles θ of the first alignment film 22 and the second alignment film 23 were different from each other. Specifically, the first alignment film 22 subjected to photo-alignment processing had a pretilt angle θ of less than 90 degrees, and the second alignment film 23 not subjected to photo-alignment processing had a pretilt angle θ of 90 degrees.

### EXAMPLE 6

The first alignment film 22 was produced in the same manner as in Example 1 except that, in the 2-division domain in FIG. 6, photo-alignment processing was performed on the first substrate 11 so that an incident direction of one area between two domains with respect to a coating film formed of a photo-alignment film material was at +45 degrees and the incident direction of the other area was at −45 degrees with respect to the band direction of the electrode. The pretilt angle θ of the first alignment film 22 was 88 degrees. On the other hand, a second alignment film 23 was produced in the same manner as in Example 1 except that, for the second substrate 12, a photo-alignment film material was applied to the substrate, pre-baking and post baking were performed, and no irradiation with ultraviolet light was then performed. The pretilt angle θ when no irradiation with ultraviolet light was performed was 90 degrees.

When the relative transmittance of the liquid crystal display 10 of Example 6 was evaluated in the same manner as in Example 1 and Example 3, the transmittance improvement effect was also confirmed in the liquid crystal display 10 of Example 6. Specifically, evaluation was performed in the same manner as in Example 1, the transmittance improvement was confirmed when the thickness of the liquid crystal layer was 2.9 μm or less, and the effect was confirmed preferably at 2.7 μm or less, and more preferably at 2.5 μm or less. In addition, regarding the pretilt angle θ, evaluation was performed in the same manner as in Example 3, and the transmittance improvement was confirmed when the pretilt angle θ was less than 88.5 degrees, and the effect was confirmed preferably at less than 88.3 degrees, and more preferably at less than 88.0 degrees. However, decrease in the transmittance when the pretilt angle θ was further reduced as in Example 3 was not confirmed. This is thought to be caused by the fact that, in this example, since alignment directions on the alignment film were not orthogonal to each other, even if the pretilt angle θ was reduced, optical rotation could not occur.

The liquid crystal display of the present disclosure described above in detail can be effectively applied to various applications, and can be used for various display devices, for example, clocks, portable games, word processors, laptop computers, car navigation systems, camcorders, PDAs, digital cameras, mobile phones, smartphones, various monitors, liquid crystal televisions, and information displays.

While the present disclosure has been described based on the embodiments, it is understood that the present disclosure is not limited to the above embodiments and structures. The present disclosure includes various modifications and alternations within the equivalent range. In addition, various combinations and forms, and additionally, other combinations and forms including only one element, or more or fewer than such elements are within the scope and spirit of the present disclosure.

### REFERENCE SIGNS LIST

10 Liquid crystal display

11 First substrate

12 Second substrate

13 Liquid crystal layer

15 Pixel electrode

17 Black matrix

19 Counter electrode

22 First alignment film

23 Second alignment film

30 Pixel area

1. A liquid crystal display comprising a first substrate, a second substrate that faces the first substrate, a liquid crystal layer disposed between the first substrate and the second substrate, and a liquid crystal alignment film formed on each of the first substrate and the second substrate,
wherein each of the first substrate and the second substrate has an electrode located on its surface on the liquid crystal layer side,
wherein the liquid crystal alignment film comprises a first alignment film formed on the surface of the first substrate on which the electrode is disposed, and a second alignment film formed on the surface of the second substrate on which the electrode is disposed, and at least one of the first alignment film and the second alignment film is a photo-alignment film,
wherein a plurality of alignment areas in which alignment directions of liquid crystal molecules in the liquid crystal layer are different from each other are formed in one pixel, and
wherein the liquid crystal layer contains liquid crystal molecules having negative dielectric anisotropy, and a thickness of the liquid crystal layer is 2.9 μm or less, and a retardation value of the liquid crystal layer is 300 nm or more.

2. The liquid crystal display according to claim 1,
wherein the thickness of the liquid crystal layer is 2.7 μm or less.

3. The liquid crystal display according to claim 1,
wherein the thickness of the liquid crystal layer is 2.5 μm or less.

4. The liquid crystal display according to claim 1,
wherein a pretilt angle of the photo-alignment film is less than 88.5 degrees.

5. A liquid crystal display comprising a first substrate, a second substrate that faces the first substrate, a liquid crystal layer disposed between the first substrate and the second substrate, and a liquid crystal alignment film formed on each of the first substrate and the second substrate,
wherein each of the first substrate and the second substrate has an electrode located on its surface on the liquid crystal layer side,
wherein the liquid crystal alignment film comprises a first alignment film formed on the surface of the first substrate on which the electrode is disposed, and a second alignment film formed on the surface of the second substrate on which the electrode is disposed, and at least one of the first alignment film and the second alignment film is a photo-alignment film,
wherein a plurality of alignment areas in which alignment directions of liquid crystal molecules in the liquid crystal layer are different from each other are formed in one pixel, and
wherein the liquid crystal layer contains liquid crystal molecules having negative dielectric anisotropy, and a thickness of the liquid crystal layer is 2.9 μm or less, and
a pretilt angle of the photo-alignment film is less than 88.5 degrees.

6. (canceled)

7. The liquid crystal display according to claim 4,
wherein the first alignment film and the second alignment film are photo-alignment films, and
wherein the liquid crystal layer has a retardation value that is equal to or greater than a value satisfying the following Formula (1):
R=−10.806×P+1264.4 (1)
in Formula (1), P is the pretilt angle (deg.) of the photo-alignment film, and R is the retardation value (nm).

8. The liquid crystal display according to claim 1,
wherein the liquid crystal molecules are aligned so that a projection direction of which a long axis direction of the liquid crystal molecules in the vicinity of the first alignment film extends and a projection direction of which the long axis direction of the liquid crystal molecules in the vicinity of the second alignment film extends are orthogonal to each other.

9. The liquid crystal display according to claim 1,
wherein the liquid crystal molecules are aligned so that a projection direction of which a long axis direction of the liquid crystal molecules in the vicinity of the first alignment film extends and a projection direction of which a long axis direction of the liquid crystal molecules in the vicinity of the second alignment film extends are antiparallel to each other.

10. The liquid crystal display according to claim 1,
wherein a pretilt angle of one of the first alignment film and the second alignment film is less than 90 degrees, and a pretilt angle of the other one is 90 degrees.

11. The liquid crystal display according to claim 1,
wherein a pixel width is 130 μm or less.

12. The liquid crystal display according to claim 1,
wherein the liquid crystal layer contains at least one compound selected from the group consisting of a compound having a biphenyl framework, a compound having a terphenyl framework and a compound having a quaternary phenyl framework in an amount of 30 mass % or more with respect to a total amount of the liquid crystal layer.

13. The liquid crystal display according to claim 1,
wherein the pixel includes, as the plurality of alignment areas, at least a first domain in which an alignment direction of the liquid crystal molecules is in a first direction and a second domain in which an alignment direction of the liquid crystal molecules is in a second direction different from the first direction and which is adjacent to the first domain, and
wherein at a boundary between the first domain and the second domain, a ratio (W/d) of a width W of an area in which a brightness is 0.5 or less when the maximum brightness in an area formed of the first domain and the second domain during white display is set as 1, to a thickness d of the liquid crystal layer is 2.0 or less.

14. The liquid crystal display according to claim 1,
wherein the pixel includes a thin film transistor as a switching element, and
wherein a semiconductor constituting the thin film transistor is any of materials obtained by performing laser annealing on an oxide semiconductor, a low temperature polysilicon, and amorphous silicon.

15. A method for producing a liquid crystal display, comprising:
a process A of forming a liquid crystal alignment film on an electrode disposition surface of each of a first substrate and a second substrate which have an electrode on their surfaces; and
a process B in which the first substrate and the second substrate obtained in the process A are disposed so that the liquid crystal alignment films face each other with a liquid crystal layer containing liquid crystal molecules having negative dielectric anisotropy located therebetween to form a liquid crystal cell,
wherein the process A includes a process in which at least one of the first substrate and the second substrate is subjected to alignment processing by performing light emission on a coating film formed using a liquid crystal alignment agent, and so a plurality of alignment areas in which alignment directions of the liquid crystal molecules are different from each other are formed in one pixel, and
wherein a thickness of the liquid crystal layer is 2.9 μm or less, and a retardation value of the liquid crystal layer is 300 nm or more.

16. (canceled)

17. The method for producing a liquid crystal display according to claim 15,
wherein a spacer formed between the first substrate and the second substrate is formed using a radiation-sensitive resin composition containing an oxime ester type radical polymerization initiator.

18. A liquid crystal display comprising a first substrate, a second substrate that faces the first substrate, a liquid crystal layer disposed between the first substrate and the second substrate, and a liquid crystal alignment film formed on each of the first substrate and the second substrate,
wherein each of the first substrate and the second substrate has an electrode located on its surface on the liquid crystal layer side,
wherein the liquid crystal alignment film comprises a first alignment film formed on the surface of the first substrate on which the electrode is disposed, and a second alignment film formed on the surface of the second substrate on which the electrode is disposed, and at least one of the first alignment film and the second alignment film is a photo-alignment film,
wherein a plurality of alignment areas in which alignment directions of liquid crystal molecules in the liquid crystal layer are different from each other are formed in one pixel,
wherein the liquid crystal layer contains liquid crystal molecules having negative dielectric anisotropy, and a thickness of the liquid crystal layer is 2.9 μm or less, and
a pixel width is 130 μm or less.
